(19) United States
(12) Patent Application Publication
(10) Pub. No.: US 2026/0328216 A1
(43) Pub. Date: Oct. 22, 2026

(54) Composite Impeller and Methods of Forming Same and of Forming Molded Composite Articles

(71) Applicant: Greene, Tweed Technologies, Inc., Wilmington, DE (US)

(72) Inventors: Sébastien Kohler, Belmont-sur-Yverdon (CH); Lionel Germanier, Lonay (CH); Samuel Stutz, Champvent (CH); Nicolas Weibel, Echichens (CH)

(73) Assignee: Greene, Tweed Technologies, Inc., Wilmington, DE (US)

(21) Appl. No.: 19/727,756

(22) Filed: Jul. 1, 2026

Related U.S. Application Data
(63) Continuation of application No. 18/669,275, filed on May 20, 2024, now abandoned.
(60) Provisional application No. 63/503,161, filed on May 18, 2023.

(51) Int. Cl. F04D 29/22; F04D 29/02

(52) U.S. Cl. CPC F04D 29/2227; F04D 29/02; F05D 2300/17; F05D 2300/2102; F05D 2300/224; F05D 2300/433; F05D 2300/434; F05D 2300/44; F05D 2300/603

(57) ABSTRACT

A method of forming an impeller may include the steps of preparing an impeller assembly of two composite pre-preg components that may be formed from a first composite including a first matrix material comprising a high-performance polymer, and continuous reinforcing fibers that are unidirectionally aligned within the first matrix material, or a second composite that may include a second matrix material including a thermoplastic polymer or a thermosetting polymer, and the reinforcing fibers. The two composite pre-preg components may include a first flange and a rib having a first end and a second end in which the first flange and the rib may be assembled such that the first end of the rib engages the first flange, positioning the two composite pre-preg components within a mold, and remolding the impeller assembly within the mold to form the impeller.

### CROSS-REFERENCE TO RELATED APPLICATIONS

This U.S. Non-Provisional patent application is a continuation of U.S. Non-Provisional application Ser. No. 18/669,275, filed May 20, 2024, which claims the benefit under 35 U.S.C. § 119 (e) to U.S. Provisional Patent Application No. 63/503,161, filed May 18, 2023, the entire disclosure of which is incorporated herein by reference.

### BACKGROUND OF THE INVENTION

### Field of the Invention

The field of the invention includes formation of articles from components formed of polymeric matrix composites that may be re-molded in a mold to form an article such as an impeller for use in compressors or pumps subject to high stresses for use in compression of light gases and other end applications.

### Description of Related Art

Compression molding for engineering thermoplastic composites for high temperature and pressure is known in the art to require the use of steel molds due to the high molding pressure and temperature conditions used in the molding operation.

Attempts have also been made to form composite impellers for use in various industries. While metallic impellers have a high precision and are known in the art, polymeric composite impellers have proven to be difficult to mold. U.S. Pat. No. 6,854,960 discloses a suggested segmented composite impeller using resin transfer molding techniques for achieving precision in parts and reducing costs. The reference suggests molding a one-blade segment which will inter-engage with other identical adjacent segments which are then assembled. Each segment is machined to conform to the design and machined. They are assembled by bonding at engaging surfaces with a bonding agent such as an adhesive or resin.

International Application Publication WO 2015/062802 describes a compressor wheel where elements are used to form a compressor wheel for use around a shaft in which a wheel back is formed separately from blades and the two are joined to have a cavity within them to reduce weight and avoid use of too much mass near the shaft area. The parts are formed using a die-cast process.

U.S. Pat. No. 4,759,690 teaches a vane-type impeller for a centrifugal pump using a number of abutting and adjacent, interconnected components. Some of the components are formed of abrasion-resistant ceramic material. The device is alleged to be improved by using a layer of a resiliently-flexible material between each of the ceramic material components. The parts are assembled by adhesive and a layer of polyurethane, and the entire assembly including the domed insert is held together by pins through the structure.

U.S. Pat. No. 9,797,255 discloses a rotary machine having a stator and a machine rotor which has a metal shaft portion and a composite impeller portion which are held together by a metal ring. The metal ring is heated, then placed on the metal shaft and allowed to cool and shrink to engage the composite impeller and secure it to the metal shaft. The impeller may be made of engineering thermoplastic polymers and may be filled with thermoset material. The composite may also include ceramics and/or metals and may include fibers such as carbon and glass fiber. Other embodiments show variations in which the composite portion is adhered using an adhesive to the metal portion. The impeller elements may be made individually or as a single part, and more than one ring may be used. The rings are formed to have a surface in contact with the metal part and a surface in contact with the composite part.

U.S. Pat. No. 5,464,325 discloses a radial coolant compressor having an impeller with vane elements for use with water vapor as a refrigerant or coolant under vacuum. The impeller is designed to operate at these conditions and for high volume flow and high circumferential velocity. The vane elements are individually connected to the hub such as by pin insert members, and are made by polymeric composite materials which may include reinforcing fibers. The vane elements have a curved configuration with extensions at their base that are engaged by support elements. The reinforcing fibers are arranged radially in the disk elements and are arranged circumferentially in the support elements.

U.S. Pat. No. 5,632,601 teaches a compressor with an impeller having a plastic hub and impeller formed using fiber reinforced thermoplastic. The impeller blades are separately prefabricated from composites and connected with a form fit to the hub. The side walls of the moving blades are formed of composite sheet that is formed to enclose a cavity which may be foam-filled for vibration damping. The walls are adhesively attached to the base plate or welded in an assembly.

In the energy field, hydrogen-based energy is a burgeoning area of development. However the cost of hydrogen transportation and storage is high due to its low compressibility. Hydrogen storage requires compression to store high volumes. Compressors for gas compression include both reciprocating and centrifugal compressors. Centrifugal compressors operate at a much higher flowrate and approximately the same efficiency, and are less expensive, but are not currently suitable for light gases such as helium and hydrogen. The reason is that compression ratio (Q) from one stage to the next in impellers within a compressor are a square function of the tip speed (Vₜᵢₚ) and proportional to the molecular mass (MW) of the gas being compressed:

$$Q ∝ MW \cdot {V}_{tip}^{2}$$

Thus, for a given Q, the Vₜᵢₚ when compressing H₂ is 2.8 times the Vₜᵢₚ that would be used to compress CH₄. Metallic impellers have a maximum tip speed limit due to the low strength to weight ratio, which inhibits efficient compression of light gases.

Typical centrifugal compressors are formed using metallic impellers, providing maximum tip speeds of 360 m/s when in service for closed impellers and about 500 m/s for open impellers.

There is a need in the art for improved methods of forming molded compressors not only to perform more efficiently in standard impeller applications, but also to meet new demands in various technology fields including the energy field where there is a need for materials to withstand high-load and/or to ensure high temperature and pressure materials, that can reduce weight, more efficiently compress light gases and/or can withstand harsh conditions.

### BRIEF SUMMARY OF THE INVENTION

Applicant has developed methods of forming multi-component polymeric composite component articles, such as impellers or other composite components, and has developed a method of making an impeller, which may be an open or closed impeller design. Further embodiments include a novel composite impellers formed using the methods herein. The methods and components herein, including the impellers exemplified herein, use thermoplastic or thermosetting polymeric composites, such as those including engineering thermoplastic polymers and/or thermoplastic high-performance polymers, or thermosetting polymers, and preferably using those polymers that are suitable when the end applications call for high-temperature and/or high-pressure conditions. Such composites incorporate continuous fibers, such as long continuous fibers that may be at least substantially or fully aligned.

In one exemplified end use herein, the impellers are suitable for use in compressing light gases such as helium and hydrogen and achieving higher tip speeds of 500 m/s or greater and as much as over about 600 m/s, or over about 700 m/s.

Such designs may also be used for more efficient and faster rotating speeds in standard compressor applications. Due to the strength of the composites and the speeds that may be achieved employing the present process and materials, impellers may be provided that improve the compression ratio in a single stage in comparison with the compression of prior art impellers. This allows for compressors to be able to achieve the same level of performance with fewer stages of impellers, in both open and closed impeller designs, providing an economic advantage in manufacture and use of impellers. By increasing speed of standard impellers, more compression occurs in a single stage allowing for reduction in the number of impellers and increased operational efficiency, at speeds of over 300 m/s, 400 m/s, 500 m/s or higher.

In the applicant's method of forming polymeric composite articles, such as an impeller, individual composite part(s) are prepared such as by composite molding, then assembled into an assembly such as a multi-component assembly and placed within a mold. In embodiments in which the assembly has openings or voids therein, the assembly is positioned within the mold using a removable core within the openings or voids. The assembly within the mold is remolded and the removable core(s) is/are removed. Such removable cores may be withdrawn, removed, machined out of the openings or may be dissolved, e.g., using salt cores or can be removed using any other techniques known to those skilled in the relevant art or to be developed.

In one embodiment herein, an impeller is included for use with centrifugal compressors or pumps, comprising a composite comprising a matrix material, which may be a matrix polymer, selected from at least one thermoplastic polymer or at least one thermosetting polymer; and at least one continuous reinforcing fiber.

The matrix material may be one or more thermoplastic polymers, for example, the matrix material may be a high-performance thermoplastic polymer selected from the group consisting of polycarbonates, linear aromatic polyesters, linear aromatic polyimides, polyurethanes, polyphenylene oxides, polyphenylene ethers, polyphenylene esters, polyphenylene ether esters, polyphenylene sulfides, polysulfones, polyether sulfones, polyphenylsulfones, polymethylpentenes, polyketones, aramids, polyaryl ethers, polyaryl ether ketones, and combinations and co-polymers thereof. The matrix material may also comprise in a further embodiment at least one polyaryl ether ketone selected from polyetherketone, polyetherketoneketone, polyetheretherketone, polyetheretherketoneketone, polyetherketoneetherketoneketone and combinations and copolymers thereof. The material may also be a thermoplastic engineering polymer selected from the group consisting of polybutadiene, polyacrylonitrile, poly(butadiene-styrene), poly(styrene-acrylonitrile), melt-processible fluoropolymers, liquid crystalline polymer, polyacetals, polyacrylates, polyamides, polyolefins, polyalkylene terephthalates, polyphthalimides, polyimides, polyetheramides, and combinations and copolymers thereof. Alternatively, the matrix material may be one or more thermosetting polymers, for example a thermosetting polymer selected from the group consisting of ethylene propylene diene rubber, ethylenepropylene rubber, thermosetting polyurethane elastomers, epoxy resins, thermosetting biscitraconicimides, bismaleimides (BMI), bismaleimide/triazine/epoxy resins, cyanate esters, cyanate resins, furanic resins, phenolic resins, urea-formaldehyde resins, melamine-formaldehyde resins, phthalocyanine resins, polybenzoxazole resins, acetylene-terminated polyimide resins, silicones, polytriazines, thermosetting polyvinyl esters, thermosetting polyurethanes, polytetrafluoroethylene, melamines, polyalkyds, xylene resins, and combinations and copolymers thereof.

The at least one continuous reinforcing fiber may comprise fibers that are at least substantially aligned within the matrix polymer. The at least one continuous reinforcing fibers may be selected from the group consisting of carbon, glass, aramid, metal, metal alloy, and natural fiber.

The impeller is preferably formed of separate elements that are comprised of the polymeric composite, and wherein within the separate elements, at least a portion of the fibers of the at least one continuous fiber may be substantially aligned in one embodiment.

In one embodiment, an impeller comprises at least one first flange comprising the composite and having an exterior surface and an interior surface, the first flange defining a first opening extending longitudinally therethrough; and at least one rib positioned on the at least one first flange such that the at least one rib engages the interior surface of at least one first flange. The at least one rib may also comprise the polymeric composite. The impeller may also further comprise at least one ring member positioned on the at least one flange and in contact with at least one of the flanges. In one embodiment, the impeller is a re-molded assembly of the first flange, the at least one rib and the at least one ring member.

The impeller described above in such an embodiment, may optionally further comprise a second flange comprising the composite, the second flange having an exterior surface and an interior surface, and wherein the second flange comprises at least one surface feature on the interior surface thereof, and the second flange defines a second opening extending longitudinally therethrough; and wherein each of the at least one rib has a first end and a second end, wherein the second end of the at least one rib engages the at least one surface feature on the interior surface of the second flange and wherein the first and the second openings are positioned to be at least substantially aligned. There may also be, in one embodiment herein, a plurality of surface features on the interior surface of the second flange and a plurality of ribs.

The interior surface of the at least one first flange may also comprise at least one surface feature, and the first end of the at least one rib may engage the at least one surface feature on the interior surface of the at least one first flange.

The at least one surface feature on each of the interior surfaces of the first and the second flanges noted above are preferably at least substantially aligned for engaging the first and second ends of the at least one rib. There may be a plurality of surface features on the interior surface of the first flange and the interior surface of the second flange and a plurality of ribs.

The impeller may further comprise at least one ring member in contact with at least one of the at least one flange. The at least one ring member may comprise a first ring member, the first ring member having an opening extending longitudinally therethrough, wherein the first ring member is configured for engaging the exterior surface of the first flange such that the first opening in the first flange and the opening in the first ring member are at least substantially aligned. The first ring member may comprise a second composite material, which may be the same as or different from the composite material and may have unidirectionally oriented fibers extending in the circumferential direction.

The impeller may also comprise a second ring member having an opening extending longitudinally therethrough, wherein the second ring member is configured for engaging the exterior surface of the second flange such that the second opening in the second flange and the opening in the second ring member are at least substantially aligned. The second ring member and the second flange may each define one or more openings for receiving fasteners to secure the second ring member to the second flange. The second ring member may comprise a metal or metal alloy.

In a further embodiment, each of the first flange and the second flange may have a circumferential outer surface extending longitudinally between the interior surface and the exterior surface thereof, and the impeller may further comprise at least one upper or lower ring member and optionally at least one outer banding ring, wherein the outer banding ring is configured to be positioned circumferentially around and in engagement with the circumferential outer surface of the first flange. The outer banding ring may comprise a third composite material which is the same as or different from the composite material, and may have at least a portion of reinforcing fibers unidirectionally oriented and extending in the circumferential direction. There may be a second outer banding ring configured to be positioned circumferentially around and to engage the circumferential outer surface of the second flange, wherein the second outer banding ring also optionally may comprise the third composite material.

In the above embodiment, the impeller may be a re-molded assembly of the first and second flange, the at least one rib and the at least one ring member and optionally at least one outer banding ring.

In the various embodiments of the impeller and methods described herein, the exterior surface of the first and/or the second flange may comprises Hirth toothing formed in an inner annular portion of the flange, such as on the exterior surface of the second flange, which may be used to mate with and engage mating Hirth toothing features on a drive part, and such drive part may be secured to the impellers herein using a counter-piece and fasteners as described herein.

The composite may comprise an engineering polymer or a high-performance polymer and the openings in the impeller may be formed using removable core molding.

The invention also includes a method of forming a multi-component composite article, comprising: preparing at least two molded polymeric composite components; assembling the at least two molded polymeric composite components into an assembly; positioning the assembly into a mold; and remolding the assembly in the mold to form a multi-component composite article.

In the method, the assembly may comprise at least one opening and the method may further comprise incorporating a removable core in each of the at least one opening prior to positioning the assembly in the mold; and removing the removable core from the at least one opening after forming the multi-component composite article. The removable core may be removed by machining or other techniques or methods as noted elsewhere herein.

The assembly in the method may be an impeller assembly, the multi-component composite article may be an impeller and the at least two molded polymeric composite components may comprise at least one first flange and at least one rib. In such an embodiment, the method may further comprise: preparing the at least one first composite flange defining an opening extending longitudinally therethrough, the first flange comprising the polymeric composite; preparing the at least one rib having a first end and a second end; assembling the first composite flange and the at least one rib so that the first end of the at least one rib engages the first composite flange to form the impeller assembly; positioning the impeller assembly within a mold and incorporating a removable core in the opening in the at least one first flange remolding the impeller assembly and removing the removable core to form the impeller.

The impeller assembly in the method may further comprise at least one ring member when assembled within the mold.

The method may also further comprise: preparing a second composite flange defining an opening extending longitudinally therethrough, the second flange comprising the polymeric composite; and wherein the method further comprises assembling the at least one first composite flange and the at least one rib with the second composite flange such that the opening in the at least one first composite flange and the opening in the second composite flange are substantially aligned and the at least one rib is situated between one of the at least one first composite flange and the second composite flange such that the second end of the at least one rib engages the second composite flange and the impeller assembly formed comprises the at least one first flange, the at least one second flange and the at least one rib.

The impeller assembly in the method may further comprise at least one ring member when assembled within the mold. The at least one ring member may comprise a first ring member having an opening extending longitudinally therethrough, wherein the first ring member is configured for engaging the first composite flange on a side thereof opposite a side of the first composite flange that engages the first end of the at least one rib, wherein the opening in the first flange and the opening in the first ring member are at least substantially aligned. The at least one ring member may comprise a second ring member defining an opening extending longitudinally therethrough for engaging the second composite flange on a side thereof opposite a side of the second composite flange that engages the second end of the at least one rib, wherein the opening in the second flange and the opening in the second ring member are at least substantially aligned.

The at least one ring member in the method may comprise at least one outer banding ring positioned circumferentially around and engaging a circumferential outer surface of the first composite flange and/or the second composite flange. The at least one banding ring may define an opening extending longitudinally therethrough configured to engage either the first composite flange and/or the second composite flange on the exterior surface thereof, wherein the opening in the at least one banding ring and the opening in the first and/or the second composite flange are substantially axially aligned.

In the method, the at least one ring member may comprise a metal, a metal alloy, or a polymeric composite comprising long continuous unidirectional fiber. In one embodiment, the second ring member may comprise a metal or a metal alloy. In another embodiment, the first ring member may comprise a polymeric composite comprising long continuous unidirectional fiber.

One or more of the first composite flange, the second composite flange and the at least one rib in the method may comprise a polymeric composite having continuous fiber. The polymeric composite in the method may comprise a thermoplastic or thermosetting matrix polymer and at least one continuous long fiber. The at least one continuous long fiber may comprise at least a portion of fibers that are at least substantially aligned and selected from the group consisting of carbon, glass, aramid, metal, metal alloy, and natural fiber.

The matrix polymer in the method may be a high-performance thermoplastic polymer selected from the group consisting of polycarbonates, linear aromatic polyesters, linear aromatic polyimides, polyurethanes, polyphenylene oxides, polyphenylene ethers, polyphenylene esters, polyphenylene ether esters, polyphenylene sulfides, polysulfones, polyether sulfones, polyphenylsulfones, polymethylpentenes, polyketones, aramids, polyaryl ethers, polyaryl ether ketones, and combinations and co-polymers thereof, and in a preferred embodiment, it may comprise at least one polyaryl ether ketone selected from polyetherketone, polyetherketoneketone, polyetheretherketone, polyetheretherketoneketone, polyetherketoneetherketoneketone, and combinations and copolymers thereof.

The matrix polymer in the method may also be an engineering thermoplastic polymer selected from the group consisting of polybutadiene, polyacrylonitrile, poly(butadiene-styrene), poly(styrene-acrylonitrile), melt-processible fluoropolymers, liquid crystalline polymer, polyacetals, polyacrylates, polyamides, polyolefins, polyalkylene terephthalates, polyphthalimides, polyolefins, polyimides, polyetheramides, and combinations and copolymers thereof.

The matrix polymer in the method may be one or more thermosetting polymers, such as those selected from the group consisting of ethylene propylene diene rubber, ethylenepropylene rubber, thermosetting polyurethane elastomers, epoxy resins, thermosetting biscitraconicimides, bismaleimides, bismaleimide/triazine/epoxy resins, cyanate esters, cyanate resins, furanic resins, phenolic resins, urea-formaldehyde resins, melamine-formaldehyde resins, phthalocyanine resins, polybenzoxazole resins, acetylene-terminated polyimide resins, silicones, polytriazines, thermosetting polyvinyl esters, thermosetting polyurethanes, polytetrafluoroethylene, melamines, polyalkyds, xylene resins, and combinations and copolymers thereof.

The impeller formed from the method, in operation, may be capable of achieving a tip speed of at least about 600 m/s, or at least about 700 m/s or higher for compression of light gases such as hydrogen or helium. The impellers may also be used in end applications in which compression ratios are increased for other standard uses at speeds of 300 m/s, 400 m/s, 500 m/s or higher.

The invention also includes a method of forming a polymeric composite article having at least one opening, comprising: preparing a polymeric composite assembly of at least two composite components, the polymeric composite assembly having at least one opening therein; positioning the polymeric composite assembly within a mold and incorporating a removable core within the at least one opening in the polymeric composite assembly; remolding the polymeric composite assembly within the mold and removing the removable core to form the polymeric composite article.

The polymeric composite article may be an impeller, and can be an open or closed impeller.

In the method, the at least two composite components may comprise a polymeric composite having at least one continuous reinforcing fiber therein. The at least one continuous reinforcing fiber may be selected from the group consisting of carbon, glass, aramid, metal, metal alloy, and natural fiber. The fibers in the at least one continuous reinforcing fiber may be aligned.

The polymeric composite may comprise a thermoplastic or thermosetting matrix polymer. The matrix polymer may be a high-performance thermoplastic polymer selected from the group consisting of polycarbonates, linear aromatic polyesters, linear aromatic polyimides, polyurethanes, polyphenylene oxides, polyphenylene ethers, polyphenylene esters, polyphenylene ether esters, polyphenylene sulfides, polysulfones, polyether sulfones, polyphenylsulfones, polymethylpentenes, polyketones, aramids, polyaryl ethers, polyaryl ether ketones, and combinations and co-polymers thereof, and in one preferred embodiment may comprise at least one polyaryl ether ketone selected from polyetherketone, polyetherketoneketone, polyetheretherketone, polyetheretherketoneketone, polyetherketoneetherketoneketone and combinations and copolymers thereof.

The matrix polymer may be an engineering thermoplastic polymer selected from the group consisting of polybutadiene, polyacrylonitrile, poly(butadiene-styrene), poly(styrene-acrylonitrile), melt-processible fluoropolymers, liquid crystalline polymer, polyacetals, polyacrylates, polyamides, polyolefins, polyalkylene terephthalates, polyphthalimides, polyimides, polyetheramides, and combinations and copolymers thereof.

The matrix polymer may also be one or more thermosetting polymers, such as one selected from the group consisting of ethylene propylene diene rubber, ethylene propylene rubber, thermosetting polyurethane elastomers, epoxy resins, thermosetting biscitraconicimides, bismaleimides, bismaleimide/triazine/epoxy resins, cyanate esters, cyanate resins, furanic resins, phenolic resins, urea-formaldehyde resins, melamine-formaldehyde resins, phthalocyanine resins, polybenzoxazole resins, acetylene-terminated polyimide resins, silicones, polytriazines, thermosetting polyvinyl esters, thermosetting polyurethanes, polytetrafluoroethylene, melamines, polyalkyds, xylene resins, and combinations and co-polymers thereof. The removable core may be removed by machining.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a top plan view of a first embodiment of a remolded composite impeller formed using the method herein prior to machining;

FIG. 2 is a cross-sectional, side elevational view of the impeller of FIG. 1 taken along line 2-2;

FIG. 3 is a bottom perspective exploded view of the impeller of FIG. 1;

FIG. 4 is a top plan view of the impeller of FIG. 1 after assembly and machining;

FIG. 5 is a cross-sectional, side elevational view of the impeller of FIG. 4 taken along line 5-5;

FIG. 6 is a top perspective view of the impeller of FIG. 4;

FIG. 7 is a top perspective view of the top composite flange of the impeller of FIG. 1;

FIG. 8 is a side elevational view of the composite flange of FIG. 7 taken along line 8-8;

FIG. 9 is a top elevational enlarged view of a composite impeller rib from the impeller of FIG. 1;

FIG. 10 is an enlarged side elevational cross-sectional view of the rib of FIG. 9 taken along line 10-10;

FIG. 11 is top elevational view of a further embodiment of a molded impeller formed using the method herein;

FIG. 12 is a side elevational view of the impeller of FIG. 11 taken along line 12-12;

FIG. 13 is an exploded top elevational view of the impeller of FIG. 11;

FIG. 14 is a top perspective view of the impeller of FIG. 11;

FIG. 14A is an example of a closed impeller which may be formed using the methods herein;

FIG. 15 is an exploded illustration representation of parts of an embodiment of the impeller of FIG. 1;

FIG. 16 is a representation of a flange mold useful for forming composite flanges for use in the invention hereof;

FIG. 16A is a photographic image of a molded composite flange for use in the invention herein having machined surface features therein;

FIG. 17 is a representative perspective view of a mold for forming a curved composite plate for use in preparing impeller ribs herein;

FIG. 18 is a photographic image of a curved flange formed using a curved mold surface;

FIG. 18A is an enlarged view of a portion of FIG. 18 showing long continuous reinforcing fiber wherein a substantial portion of individual fibers within the plies of the long reinforcing fiber are substantially aligned within the part;

FIG. 19 is a photographic image of a rib cut from the curved flange of FIG. 17;

FIG. 20 is a photographic image of a ring for use as at least one compression member formed having at least a portion of the continuous long fiber in the matrix substantially aligned in a circumferential direction;

FIG. 21 is a photographic image of an assembly of impeller component parts remolded in a mold and the method herein;

FIG. 22 is an exploded perspective view of molded composite component parts and removable mold inserts for use in assembling the components for remolding;

FIG. 23 is a representation of the component parts of FIG. 22 assembled in a mold for the remolding step of the method;

FIG. 24 is a partial cross-sectional perspective view of the impeller of FIG. 11 having two outer banding rings molded thereon as a compression member;

FIG. 25 is a perspective view of the rear of a further embodiment in which Hirth toothing is provided for connection of the impeller to a driving part such as a shaft line or similar apparatus;

FIG. 26 is a longitudinal, cross-sectional view of the impeller design of FIG. 25 modified to include optional banding rings;

FIG. 27 is an exploded view of the impeller of FIG. 25 arranged to engage a driving part to mate with the Hirth toothing on the impeller and a counter-piece for fastening the impeller to the driving part; and

FIG. 28 is a photographic image of an impeller formed from the process herein using the design of FIG. 25 and the composite described in the Examples herein.

### DETAILED DESCRIPTION OF THE INVENTION

In the invention herein are new multicomponent composite articles which may be formed by a molding method using polymeric composites including a polymeric matrix material and continuous fiber as a reinforcing material and assembling the component parts within a mold and then remolding the component parts. In one embodiment, in the invention, such a multicomponent part is exemplified as an impeller, which is shown in one example herein, as a closed impeller for use in compressors and pumps and may be used for compressing light gases including helium and hydrogen. An impeller herein may also be made that has only one flange and/or that is an open impeller comprising a composite as described herein. The invention herein further includes a method for forming multi-component polymeric composite articles, such as the impellers shown and described herein, which articles may have one or more openings or voids. Such articles may have multiple component composite parts and/or may include many voids. The method uses such individual molded component parts or elements, assembles them to form an assembly of the components, places them in a mold, and remolds the assembly to form the composite article. The openings or voids in one embodiment herein may include removable cores in the openings prior to remolding. The assembly of components is remolded under heat and pressure and the removable core removed is then removed, such as by removing a collapsible mandrel or similar core or by machining or another other removable core technique known or to be developed in the art to form the article. It should be understood by one skilled in the art based on this disclosure that the methods may be used to make a variety of articles and is not limited to the impellers exemplified herein.

Regarding the articles and impellers herein, such articles comprise polymeric composites, having a polymeric matrix material and a reinforcing agent, and with respect to impellers, may be open or closed impeller designs which can all be formed using the methods and materials described herein. The impellers may be formed using a single-flange design, or an impeller having two or more flanges. In one embodiment herein, flanges are exemplified to show impellers with two flanges, although such designs could be modified to have additional flanges or could be formed omitting one of the two flanges.

Preferred matrix polymers for use in the composites herein are preferably polymeric plastics and resins suitable for molding and being loaded or filled with continuous long fiber reinforcement as well as those able to accept other fillers as needed. Such matrix polymers may be thermoplastic or thermosetting materials.

Preferably, the matrix polymer is at least one thermoplastic polymer that flows under application of heat. Preferred thermoplastic matrix polymers are those selected from the engineering and high-performance polymers. When such materials are reinforced they are preferably suitable for use in end applications which are under a high mechanical load, and depending on the polymeric matrix material that take also place at high temperatures and/or high pressures, with the understanding that the level of temperature or pressure will vary with the polymer matrix material chosen.

Exemplary engineering thermoplastics include polybutadiene, polyacrylonitrile (PAN), poly(butadiene-styrene) (PBS), poly(styrene-acrylonitrile) (SAN), fluoropolymers (including melt-processible fluoroplastics (such as copolymers of tetrafluoroethylene (TFE) and at least one perfluoroalkylvinyl ether (PAVE) (PFA), copolymers of TFE and at least one other perfluorinated alkylene (such as hexafluoropropylene) (FEP)), poly(chlorotrifluoroethylene), polyethyl chlorotrifluoroethylene (ECTFE), polyethyltrifluoroethylene (ETFE), polyvinyl fluoride (PVF) and polyvinylidene fluoride (PVDF)), ionomers, liquid crystalline polymer (LCP), polyacetals, polyacrylates, polyamides (such as NYLON 12, NYLON 6), polyolefins such as polyethylene or polypropylene and their copolymers, polyalkylene terephthalates (such as polyethylene terephthalate and polybutylene terephthalate), polyphthalimides, polyimides, polyetheramides, and polyamideimides as well as copolymers or combinations (such as blends or alloys) of such polymers.

Examples of high-performance thermoplastic polymers include, for example polycarbonates, linear aromatic polyesters, linear aromatic polyimides, e.g., polymethacrylimide (PMI), polyamide-imide (PAI), polyether (ether-imide) (PEI), and poly(imide-sulfone) (PISO), polyurethanes, polyphenylene oxides (PPO), polyphenylene ethers, polyphenylene esters, polyphenylene ether esters, polyphenylene sulfides (PPS), polysulfones (PSU), polyether sulfones (PES), polyphenylsulfones (PPSU), polymethylpentenes, polyketones, polyaryl ethers (PAE), such as polyaryl ether sulfone (PES) and polyaryl ether nitrile (PEN), aramids, e.g., poly(p-phenylene terephthalamide) and poly(m-phenylene isophthalamide, and polyaryl ether ketones (PAEK), and other similar PAEs and PAEKs, e.g., polyetherketone (PEK), polyetherketoneketone (PEKK), polyetheretherketone (PEEK), polyetheretherketoneketone (PEEKK), polyetherketoneetherketoneketone (PEKEKK) and similar PAEs. and PAEKs, also copolymers and combinations (such as blends or alloys) of these materials with other polymers may be used.

For less demanding environments, the matrix material may include more standard thermoplastic matrix resins, such as standard thermoplastic polyolefins (such as polyethylene, polybutylene, polypropylene, high-density polyethylene, low density polyethylene), poly(acrylonitrile-butadiene-styrene) (ABS), standard polystyrenes, cellulosic resins (such as ethylcellulose, cellulose acetate, cellulose acetate butyrate, cellulose acetate propionate, and cellulose nitrate), polyethylene vinyl alcohols (EVA), polyvinyl chlorides (PVC), and polyethylene vinyl acetates (PVA).

Also possible for use as matrix materials within the invention are thermosetting materials, such as certain epoxies and thermosetting materials. Preferably, such materials are able to achieve properties similar to engineering and high-performance thermoplastic properties in terms of composite performance when intended for use in demanding end application conditions such as high-temperature and high-pressure. Suitable thermosetting matrix materials include certain elastomers (such as ethylene propylene diene monomers (EPDM), ethylenepropylene rubber (EPR) and thermosetting polyurethane elastomers), epoxy resins, thermosetting biscitraconicimides (BCI), bismaleimides (BMI), bismaleimide/triazine/epoxy resins, cyanate esters, cyanate resins, furanic resins, phenolic resins, urea-formaldehyde resins, melamine-formaldehyde resins, phthalocyanine resins, polybenzoxazole resins, acetylene-terminated polyimide resins, silicones, polytriazines, thermosetting polyvinyl esters, thermosetting polyurethanes, polytetrafluoroethylene, melamines, polyalkyds, and xylene resins.

While the above polymers are preferred, the above-noted list should not be considered to be exhaustive, and one skilled in the art would understand based on this disclosure that other thermoplastics or thermosetting materials could be used in the invention without departing from the scope thereof, provided that they are suitable for forming the composite articles herein.

Co-polymers (polymers formed of two or more monomeric species in random or block form, or graft copolymers, any of which may have multiple monomeric components or reactants) of each or any of the above polymers may also be used within the scope of the invention, whether known or to be developed. In addition, depending on the polymer chosen, the polymers may be derivatized and/or include functional groups (whether terminal and/or on the chain), branched and/or straight chain backbone structures, additional locations of unsaturation along the chain or side groups, and the like. Functional groups which may be provided include aryls, ketones, acetylenes, acid groups, hydroxyl, sulfur-containing groups, sulfates, sulfites, mercapto, phosphato, carboxyl, cyano, phosphite, oxygen/ether or esters (also can be incorporated within the chains or side chains), carboxylic acid, nitric, ammonium, amide, amidine, benzamidine, imidizole, and the like. The selected polymer(s) may also be used in mixtures, blends, alloys or copolymerized with each other or other monomers to form new random, block or graft copolymers.

Preferred embodiments herein include matrix materials that are high-performance plastics such as polyphenylene sulfides, polyetherimides, polysulfones, and other aromatic polymers including the PAE and PAEK polymers, including PEEK, PEK, PEKK, PEEKK and PEKEKK, as well as polyamides, melt-processible fluoropolymers, as well as thermosetting materials such as epoxy resins.

The composite materials provided herein preferably include long fiber reinforcement, that is preferably continuous long fiber. It is within the scope of the invention that more than one composite may be used and blended in forming articles herein. Such as using multiple composite flanges and blending them prior to or within a mold. In such a case, a second or other composite used could comprise the same or a different thermoplastics and/or thermosetting matrix material with the same or a different form of fiber or filler reinforcement.

Examples of suitable long reinforcing fiber materials include, for example, without limitation, various long reinforcing fibers that are inorganic fibers such as ceramic fibers, glass fibers, graphite fibers, carbon fibers, quartz fibers, alumina fibers, silicon carbide fibers, basalt fibers, boron fibers, aramid fiber, metal fibers, metal alloy fibers, natural fibers, and combinations thereof such as glass/carbon, glass/graphite/carbon, graphite/carbon, and ceramic/glass. Further organic fibers, such as thermoplastic and thermosetting reinforcing long fibers, may be used, having first fiber materials such as aramid fibers, polybenzoxazole fiber, and the like, which may be used alone or in a blend with glass, metal, ceramic or carbon fibers.

Preferred long fiber materials include ceramic, glass, graphite, carbon, and/or plastic (thermoplastic and thermoset) fibers (such as aramid fiber (available as Kevlar®, Twaron® and Technora®) or polybenzoxazole fiber available as Zylon®)).

The fiber and matrix composites may be provided in a variety of forms, including unidirectional tapes, fabrics, mats, filaments, and other long fiber materials. Laminates of such material may also be formed using various methods known or to be developed in the art, such as hand deposition, automated tape layup, three dimensional filament printing and the like.

In fiber blends or combined fibrous reinforcements, additional fibers may be provided in the form of chopped strands, filaments or whiskers to the fiber matrix prior to impregnation. Further, such blends may include bundles, tows and braids extending in a long fiber direction and/or various woven or blended fibrous materials extending in more than one direction to provide strength and/or other desired properties.

The continuous fibers may be unidirectional or bi-directional continuous fibers (preferably bidirectional fibers would have approximately 50% of the fibers in the parallel direction and approximately 50% of the fibers in the perpendicular direction), stretch-broken, tows, braided fibers and woven continuous fibers. Additionally, the fibers may be braided and/or commingled fibers.

In one embodiment, the reinforcing fibers are unidirectional and at least a portion of them may be substantially aligned within one or more of the elements of the article or aligned circumferentially for additional ring member or clamping or banding ring elements. Examples of fiber diameters for some long fibers useful in the invention include, but are not limited to, about 0.1 microns, about 5 to about 15 microns, and about 7 to about 10 microns. For example, boron fibers may be used that range from 100 microns to about 140 microns, and glass fibers may range from about 5 to about 25 microns, but such ranges are not intended to be limiting. Basalt fibers, also, for example, may be used that range from about 10 to about 20 microns. Not all of the fibers need to be aligned in the longest dimension as other fiber orientations may also be used for suitable end results. In embodiments herein, desired article properties may be achieved when at least a portion of the fibers are at least substantially aligned in a direction within the component or article to provide strength, for example, in the longest dimension or, in round or arcuate components in a more circumferential direction. Combinations of such orientations along with fibers extending in other directions may be used and can enhance the desired results.

In embodiments herein, the long fiber reinforcement, for example, may be about 30% or more, preferably 40% or more, more preferably 50% or more, e.g., may be about 60% to about 90% by volume of a composite used to form the pre-preg, or in the resulting articles and/or component parts formed herein with respect to the total volume of the composite. It is preferred that the long fibers are about 40% to about 80% by volume of the composite, and most preferred that they are about 50% to about 70% by volume of the composite, with the understanding that different fibers having different diameters may make the preferred volume higher or lower.

The elements or components of the article made herein, may be formed from composites herein which may be provided as is or used to form the element using a long fiber-containing pre-preg, such as a flake, plate, sheet, rod stock, fabric, tape or the like, through any suitable techniques or structures known or to be developed in the art may be used for providing the components using the composites herein, provided that the resulting composite structural component is suitable for use in an assembly having an assembled structure, particularly one in which there are may be one or more openings and/or so as to form the assembled articles, for example, the impellers herein. In one embodiment, a continuous fiber structure may be used to form one or more of the structural elements of the assembly, such as an impregnated continuous fiber tape, fabric or the like. Such tapes or other continuous fabric, tape, rod stock and the like may be cut to various lengths but should retain long fiber structures. Structures having reinforcing fibers primarily having a length to diameter ratio of greater than about 100 are useful herein.

As used herein, continuous fibers in such structures are those which generally have a length of at least about 0.20 in., and in embodiments long continuous fibers may be those having a length of at least about 0.5 in. (1.27 cm). Lengths of at least 0.5 in., in some embodiments herein, may contribute to enhancement of mechanical properties in the resulting articles. As processing such fibers may not be as easy as shorter lengths, one skilled in the art would understand that fiber length can be selected to balance the mechanical properties and processing conditions for a given process. It is preferred that in forming elements of the articles from such structures or directly from a composite by molding, that the resulting components retain at least some and preferably a large portion of their original long reinforcing fiber length and that in certain aspects as described further hereinbelow, at least some portions of the long fibers may be substantially aligned along the structural features of the article such as in forming a ring for use in the assembled article, wherein the ring is molded to have at least a portion of circumferentially extending continuous and substantially aligned long reinforcing fibers. The portion of fibers in alignment and within the matrix may be adjusted consistent with the ability of the chosen matrix material to accept the fiber loading as well as to adjust the end properties of the resulting article formed and/or of its component parts.

The polymeric composite matrix may also incorporate other various additives that may be incorporated by blending with the polymeric matrix material. Examples of such additives include other reinforcing agents aside from the continuous fiber, pigments, dyes, glass, ceramic, mesh, honeycomb, mica, clay, organic colorants, plasticizers, thixotropic agents, flame retardants, UV absorbers, extenders, stabilizers, silicon dioxide, silica, alumina, talc, glass fibers, barium sulfate, glass spheres, PTFE short fibers, TFE copolymer short fibers, other reinforcing fibers of varying length, ribbons or platelets, wollastonite, titanate whiskers, compatibilizers, rheological or thixotropic agents, antistatic agents (which may also be incorporated through use of functional groups and/or graft copolymers provided to the thermoplastic matrix), chopped carbon fibers, and other similar fillers, tribological additives and reinforcing agents. It is preferred that such additives (over and above the presence of the first thermoplastic composite material) be present in an amount no greater than about 10% of the composite based on the total weight of the composite, however, more or less may be used.

In addition, it is within the scope of the invention that the fiber material may be a blended material, i.e., that more than one fiber may be used in combination for impregnation by a polymeric matrix material to form composite materials to be used herein, including for example, without limitation, glass/carbon, glass/graphite/carbon, graphite/carbon, aramid/glass, ceramic/glass and PTFE or TFE copolymer fiber/carbon blends. In fiber blends or combined fibrous reinforcements, additional fibers may be provided in the form of chopped strands, filaments or whiskers to the fiber matrix. Further, such blends may include any range of potential woven or blended fibrous materials provided sufficient strength and other desired properties are retained.

The components of the impeller may also incorporate pre-formed elements. For example a commercial part such as a fiber-reinforced ring formed of a desired composite herein having unidirectional circumferentially extending long continuous fiber reinforcement may be incorporated into the assembly to be molded without use of a specially prepared composite component. Similarly, commercially available molded sheet of a desired composite having at least a portion of the long continuous reinforcing fiber substantially aligned in a desired thickness and shape may be used or machined to a size for use in the assembly herein.

When forming component parts herein from such polymeric composites (including pre-pregs, unidirectional tapes and the like) the component parts may be initially molded using suitable molds of various types as are known in the art to best obtain the composite articles and preferably achieve the best orientation of fiber within the component parts herein.

Articles, such as the impeller herein may be formed of separate elements (components) as noted above that are preferably formed from the same or a compatible polymeric composite. In preferred embodiments herein, for uniform strength and molding conditions, the same or a composite with similar molding conditions for the various components is used. For strength, preferred fiber reinforcement includes continuous reinforcing fiber (such as bundles or tows and/or individual fibers therein) extending through the polymeric matrix. Such fibers are in embodiments herein long fiber that are substantially or fully unidirectionally aligned or at least substantially aligned, and, may in other embodiments extend in a direction along a particular dimension or direction within one or more of the component parts. For round parts such as rings or hoops, the fibers may extend circumferentially around the component within the polymer matrix. While this is a preferred arrangement for forming the impellers herein, other types of reinforcing fiber techniques may be used, such as using pre-preg composites and pressing the parts in a two-cavity mold in which the polymer within the composite is expended and the long fibers are randomly dispersed as described in detail in U.S. Pat. No. 10,160,146. Other suitable component part molding techniques for composites may be uses to form individual components of the article assembly. Any suitable molding technique known in the art or to be developed may be used and adjusted according to the knowledge in the art to use the preferred molding temperatures and techniques for the matrix polymeric material or composite and to preferably achieve the desired fiber orientation.

The invention will now be further explained with respect to the example impeller hereof as a composite article formed from multiple components (flange(s), rib(s) and preferably some compression member(s)) according to the methods herein. While the method is explained with respect to the impeller for convenience, it would be understood by one of skill in the art, that the molding methods and techniques herein could apply to other assembled articles having one or more voids therein using varied mold designs.

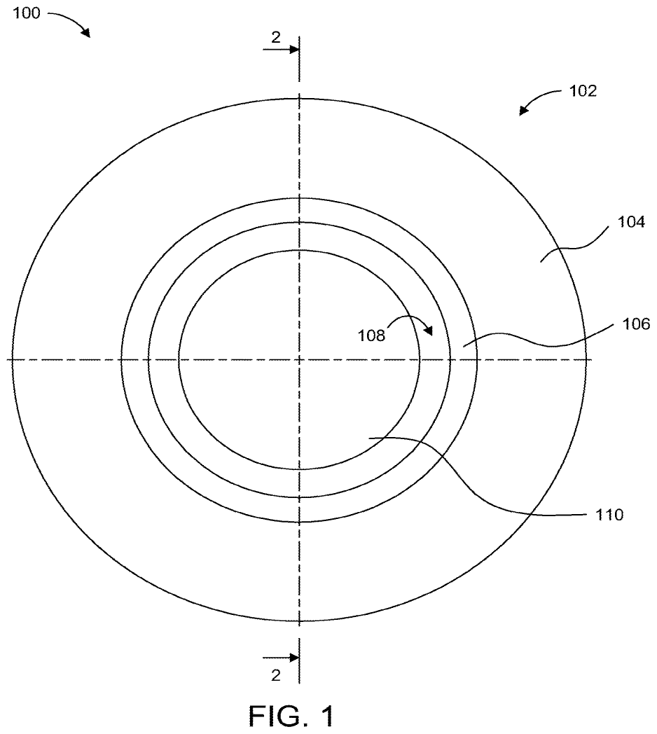

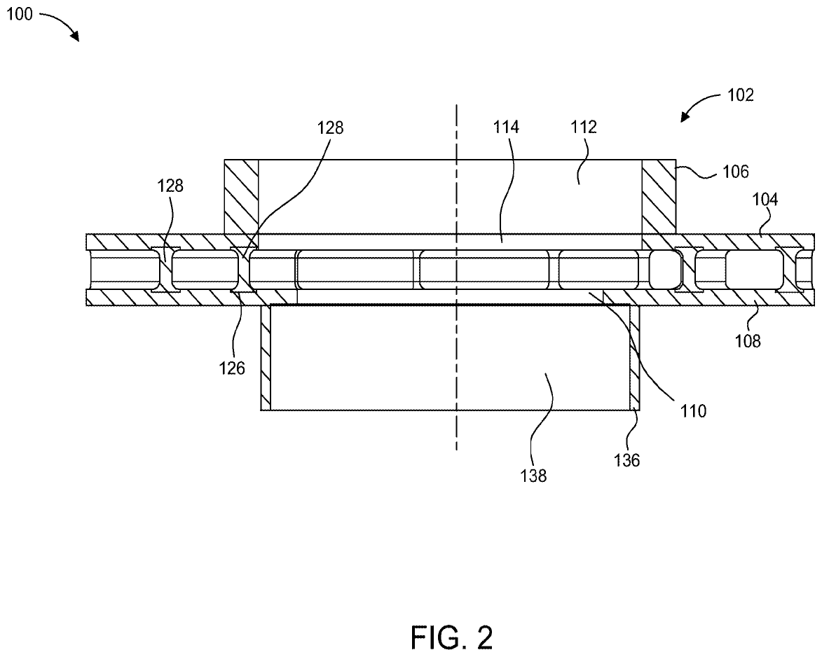

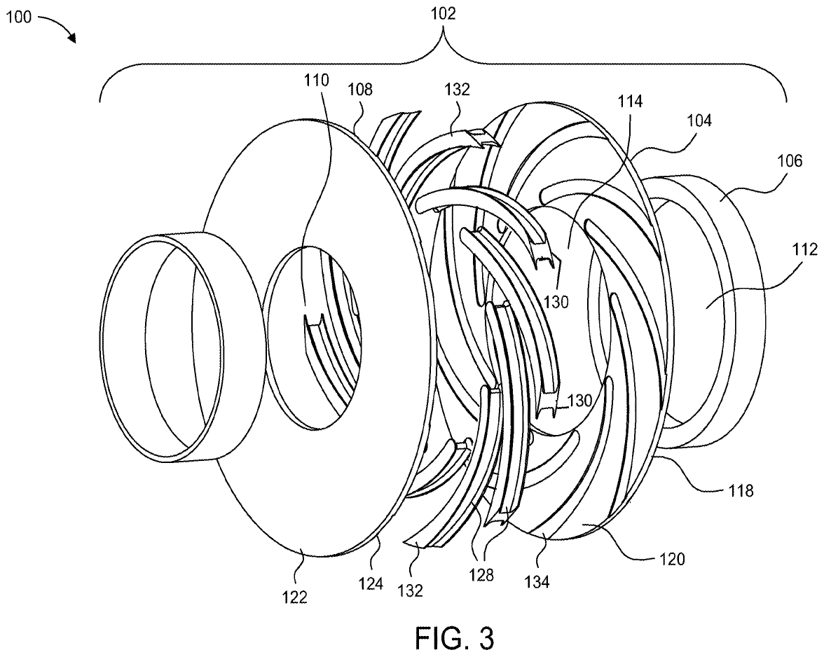

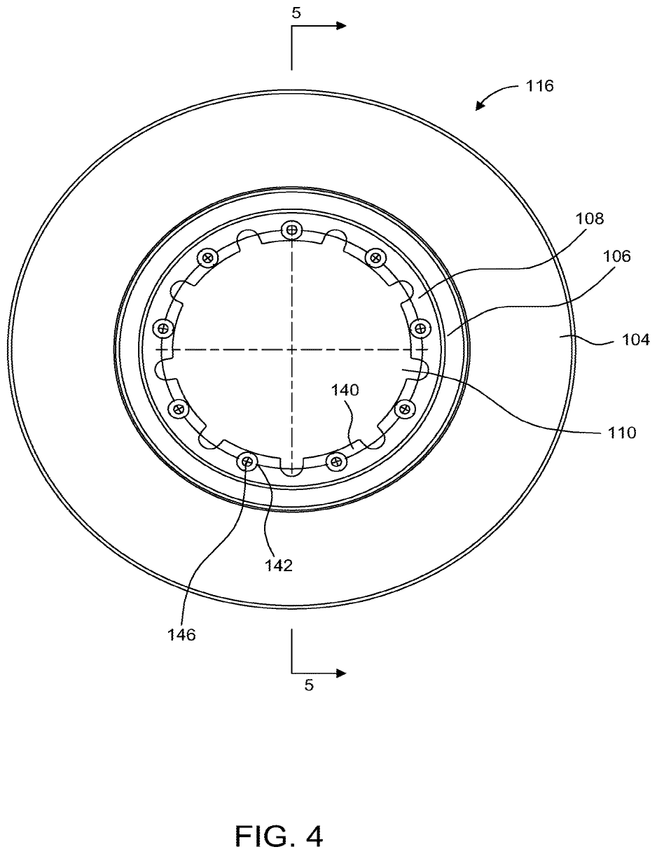

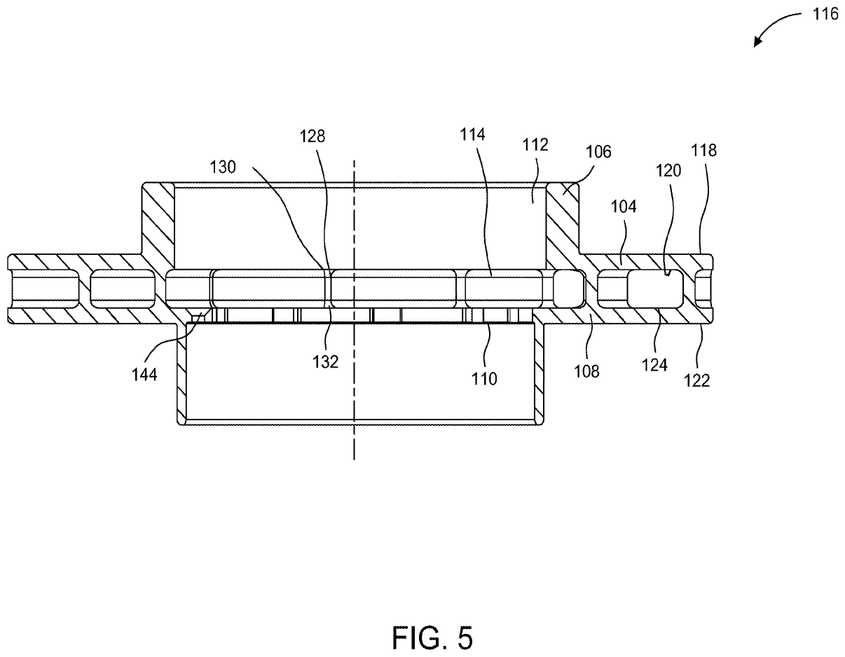

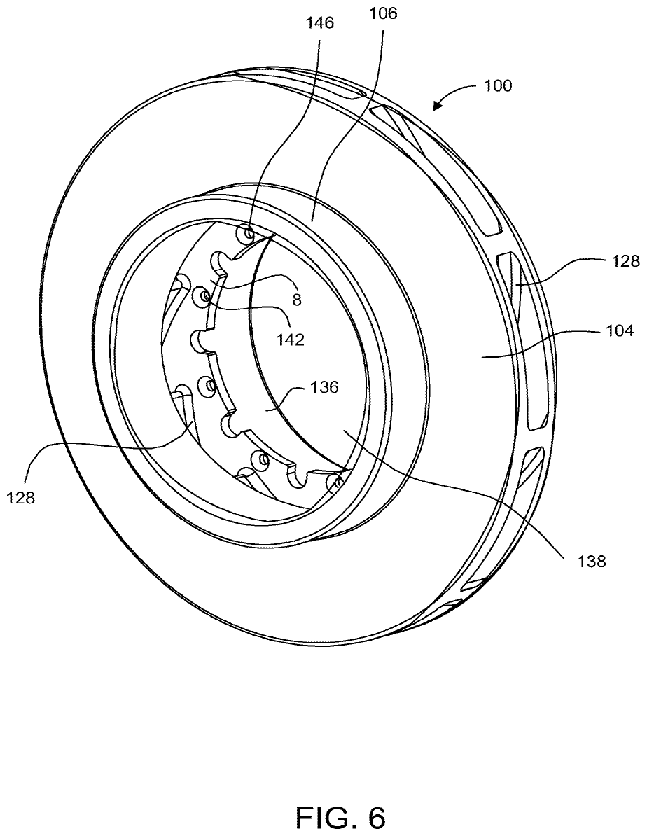

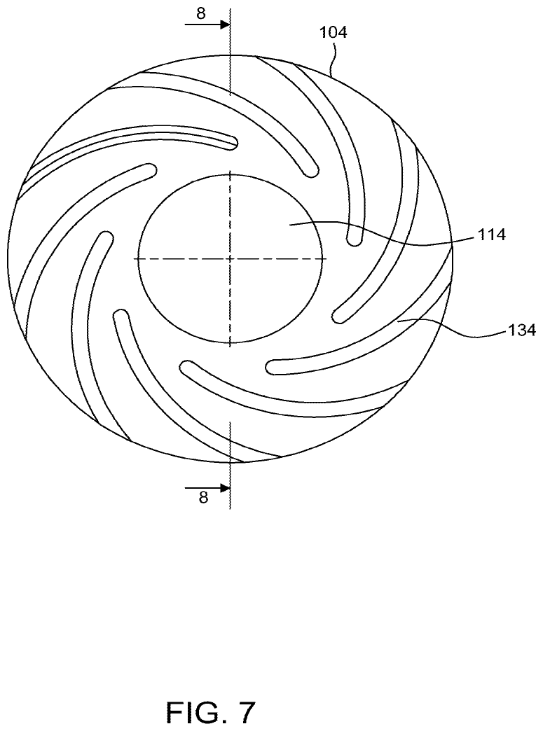

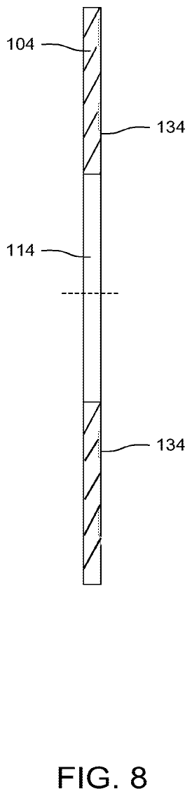

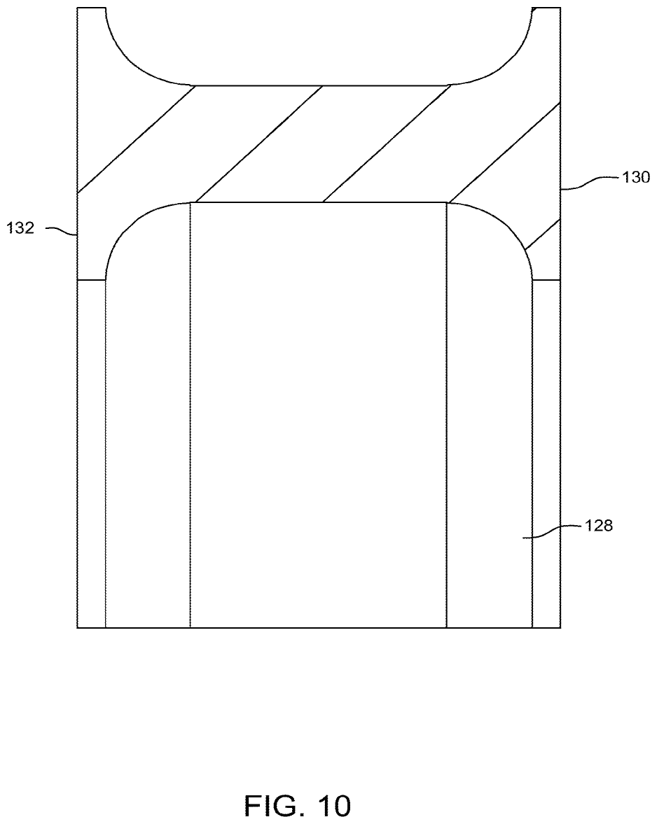

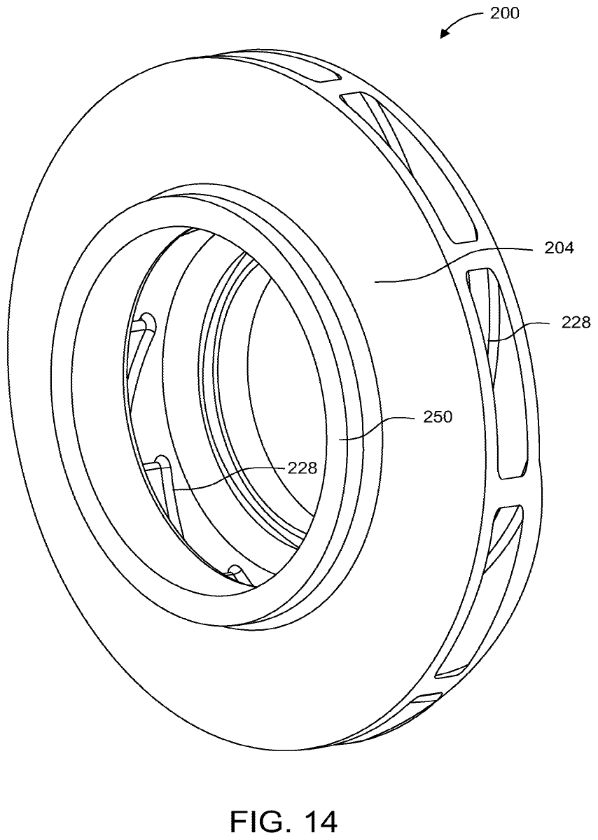

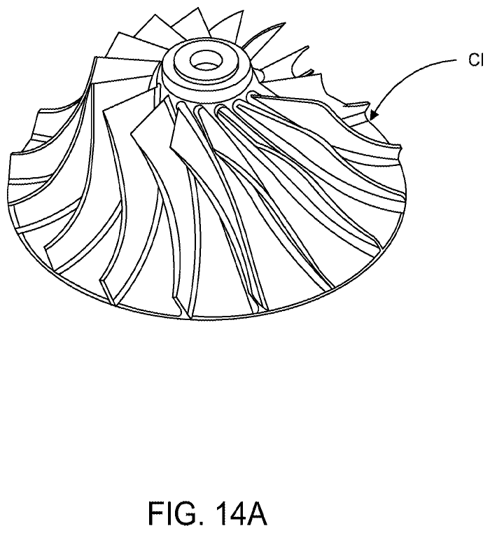

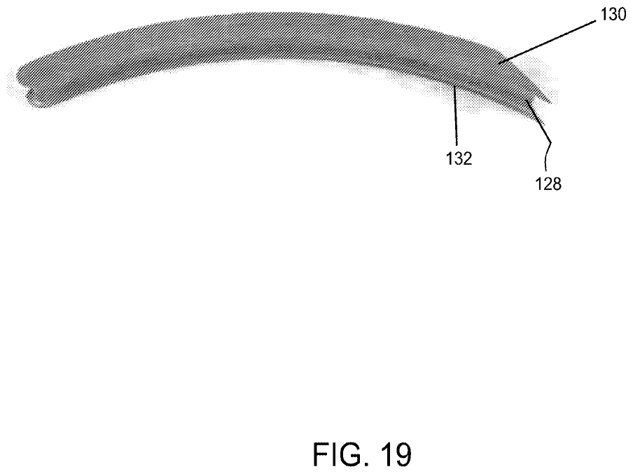

In an embodiment of the impeller herein and variations thereof, referred to generally as impeller 100, the impeller will be described with reference to FIGS. 1-10 and 15-23. The impeller 100 once remolded and formed is shown in FIG. 6. FIGS. 1-3 show the assembly 102 prepared for forming the impeller 100 from component parts prior to machining. In FIGS. 1-3, the first composite flange 104 can be shown on an upper portion of the assembly. The first composite flange has an opening 114 extending longitudinally therethrough. A first ring member 106 is shown that is formed from a composite having a polymeric matrix material and unidirectional continuous fiber at least a portion of which extends in a substantially aligned manner through the composite. The first ring member 106 defines an opening 112 extending longitudinally therethrough that is preferably centered axially in the first ring member and is substantially aligned, and preferably fully axially aligned with the opening 114 in the first composite flange 104. The first flange has an exterior surface 118 and an interior surface 120. As shown, embodiment 100 includes two composite flanges, 104, 108. The second composite flange 108 has an exterior surface 122 and an interior surface 124. It should be understood that an open impeller with only one flange may be made according to the methods herein. A suitable open impeller design is shown as an example herein in FIG. 14A. The first ring member 106 and the first composite flange 104 while shown as independent pieces for formation, may also be formed as or may be formed into a single component composite part.

The second flange in embodiment 100 may have at least one surface feature 126 on the interior surface 124 thereof, for seating at least one rib 128. There are preferably a plurality of such features 126 and they are preferably commensurate with the number of ribs 128. As with the surface features, 126, there may be one or a plurality of rib(s). The surface features may be machined or molded into the interior surface 124 of the second composite flange 108 and may be positioned to follow the design shape, such as a curvature, of the impeller ribs 128. Such feature(s) assist in aligning the impeller rib(s) and facilitate remolding of the assembly.

The second composite flange 108 defines an opening 110 extending longitudinally therethrough that is substantially aligned with and preferably fully axially aligned with the opening 112 through the first ring member and the opening 114 through the first composite flange. The rib(s) 128 have a first end 130 and a second end 132. The rib(s) are preferably positioned between the first and the second flanges 104, 108 such that the second end 132 of each rib 128 engages one of the surface feature(s) 126 on the interior surface 124 of the second flange 108.

The rib(s) like the flanges are preferably formed of a polymeric composite material having the same or similar molding conditions to that used to form the first and the second composite flanges and/or the first ring member, however, molding conditions may be modified or changed as desired depending on the particular article design being made according to the methods herein. Preferably, for consistency, the same composite is used for each of the component parts, although the polymeric matrix material and the nature of the reinforcing fiber or other additives may be varied depending on design properties. In a preferred embodiment herein, engineering polymers and more preferably, high performance polymers are used as the matrix polymer(s) or thermosetting material are used, the continuous fiber used is preferably long continuous carbon fiber in the composite used for the various components as described above and the component parts are preferably formed having fiber alignment for suitable reinforcement in the component part consistent with the desired alignment in the final assembled article.

The interior surface 120 of the first composite flange 104 may also include at least a surface feature(s) 134, such that the first end 130 of each of the impeller rib(s) 128 engages the surface feature(s) 134 on the interior surface 120 of the first flange 104 in the same manner that the ribs 128 on their second end 132 engage the surface feature(s) 126 on the interior surface 122 of the second flange 108.

The surface feature(s) 134, 126 on each of the respective interior surfaces 120, 124 of the first and the second flanges 104, 108 are preferably at least substantially aligned for engaging the first end 130 and second end 132 of the at least one rib, and preferably are fully axially aligned when the rib(s) are designed as shown to be perpendicular to the interior surfaces 120, 124 of the first and second flanges 104, 108. If the ribs were configured to connect between the two flanges at an angle for design purposes, the surface features need not be aligned, but should be designed to engage the respective ends of the ribs.

The impeller as shown may include one or more ring members. Ring members are intended to be used in or on the impellers when desired to account for stress on the component parts once remolded into an article and placed into use or can be used, for example, for fretting or other wear issues and added to the molded impeller after it is formed.

One such ring member for incorporation into the impeller may be, for example, the first ring member 106 as noted above which is incorporated in the assembly to reduce the stress concentration that occurs near the center of the flanges based on modeling conducted by applicant.

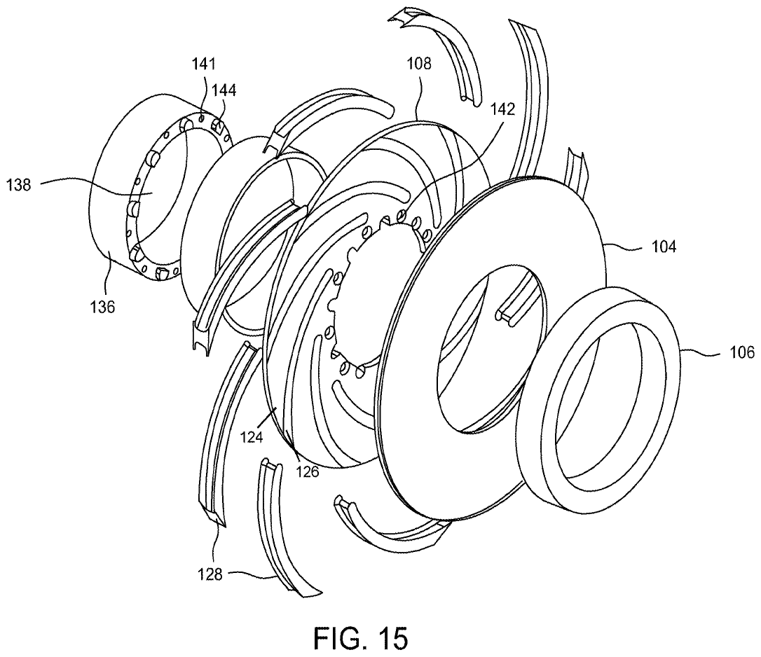

A further ring member may be introduced as shown that further serves the purpose of fretting while the impeller is in use. In the present embodiment, as best shown in FIGS. 6 and 15, a second ring member 136 may be added to the impeller. The second ring member defines an opening 138 extending longitudinally therethrough, which is also preferably axially aligned with the openings in the composite flanges and the first ring member 106. The second ring member 136 is preferably configured for engaging the exterior surface 122 of the second flange 108 after formation of the impeller by remolding as described further hereinbelow, such that the opening 110 in the second flange 108 and the opening 138 in the second ring member 136 are at least substantially aligned, and preferably fully axially aligned.

As shown best in FIG. 15, the second flange 108 may have fastener extensions 140 having holes 142 there through for receiving fasteners 146 and the second ring member 136 may have a series of mating fastening holes 141 machined therethrough as well, and also may be configured to include drive pins 144 as shown in FIG. 15 for transferring torque to the impeller. The second flange and the second ring member may be mated and machined to fit together for stability in use in an end application. The second ring member may be formed of a composite or a metal or metal alloy. In this embodiment, a metal or metal alloy is preferred. Fasteners 142 may be incorporated to securely attach the second ring member to the second composite flange.

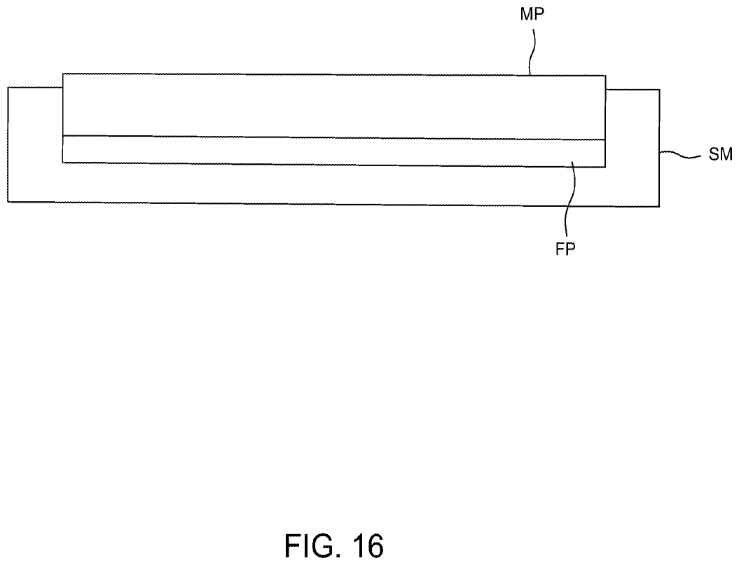

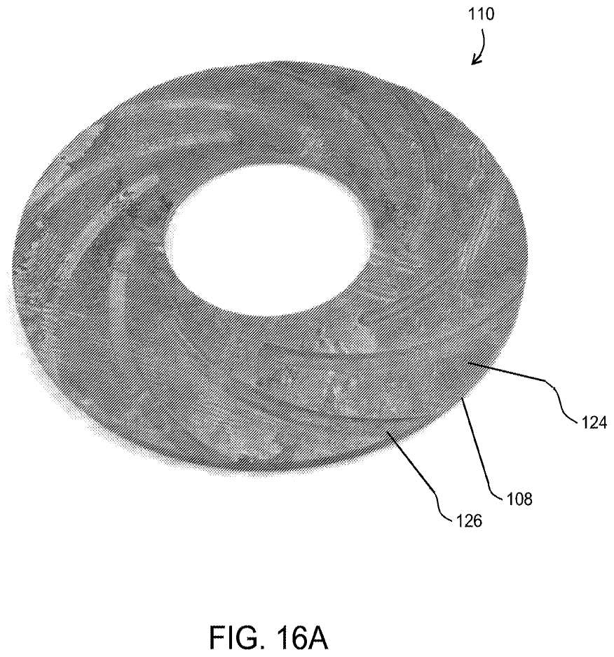

As shown in FIG. 16, the composite flanges may, for example, be formed from a flat composite flange FP in a mold SM having a molding piston MP capable of putting downward pressure on a flange FP within a heated mold. The flange FP may be round, square or other shapes or machined to a desired shape, for example, a one square foot flange may be formed in square mold and used or machined to a desired shape. The flanges may be machined or molded to shape and the features may be molded or machined into the flanges as described above. An image of one of the machined flanges according to the invention is shown in FIG. 16A formed of a polyetheretherketone high performance polymer with substantially aligned carbon fibers using AS4 fiber in a PEEK matrix, having 60% volume fraction of fibers (a [45/90/−45/0]_{NS} layup (QI laminate)). Two such sample flanges were made. In preferred embodiments, flat molds such as those shown in representation in FIG. 16 can provide component parts that may be machined into a desired flange shape and the fibers may be oriented to form a quasi-isotropic laminate.

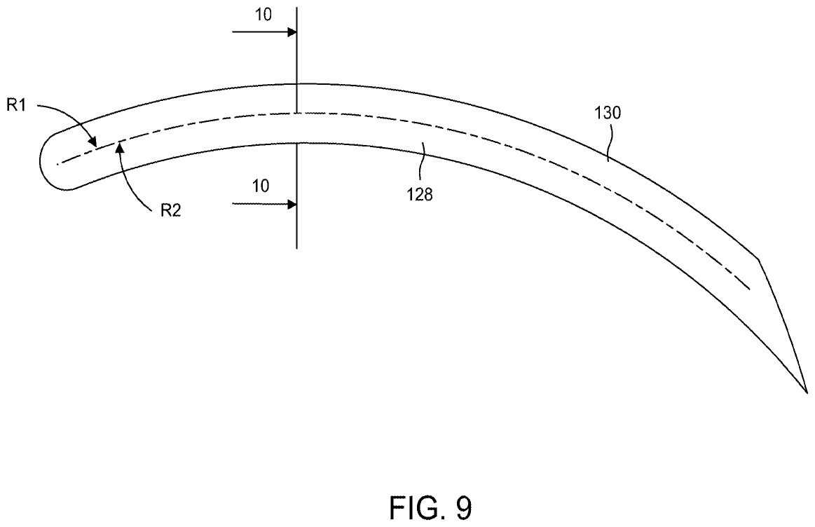

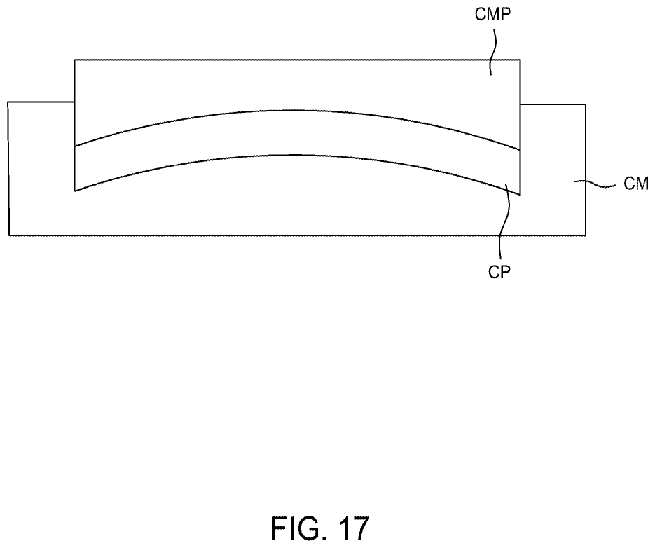

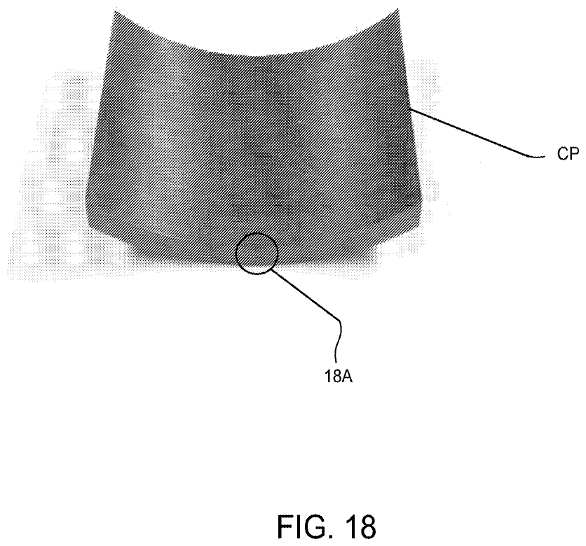

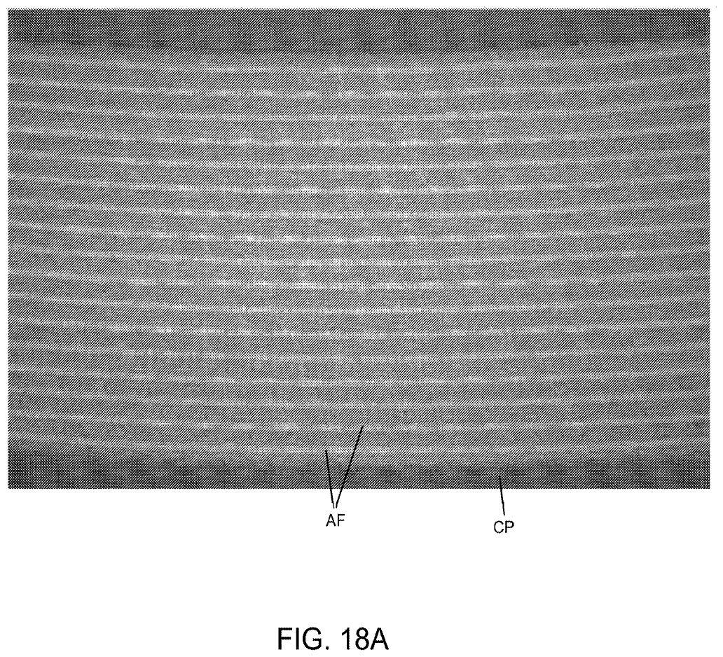

In forming the rib(s) 128, a curved molded plate CP is may be formed having the desired curvature of the rib design. Each of the ribs 128 may be cut from one or more than one curved plate CP. A representative curved mold CM is shown in FIG. 17 having a curved mold piston CMP herein for forming a curved plate CP as shown in FIG. 18 and may be subject to pressure in a heated mold by piston CMP. The curved plate of FIG. 18 in this embodiment was made of the same composite noted above used in forming the first and second composite flanges 104, 108. FIG. 18A shows a greatly enlarged portion of the image of the curved plate in FIG. 18 to illustrate the alignment of the long continuous carbon fibers AF therein. The ribs 128 as shown in FIG. 9 are machined from the curved plate CP. The plate shown was used to form 9 ribs and the curved plate was formed using a polymer plate having at least substantially aligned continuous carbon fiber plies (see FIG. 18A) within a polyetheretherketone polymer matrix ([(0/45/90/−45)x]s). In preferred embodiments, curved molds were used to form curved plates from which ribs were machined. The curvature allows the 0° fiber orientation to be chosen according to the chord line of the rib, with the laminate being quasi-isotropic.

While these molds are preferred, other molds of varying types may be used to form component parts and elements of designs of different articles, including different impeller designs.

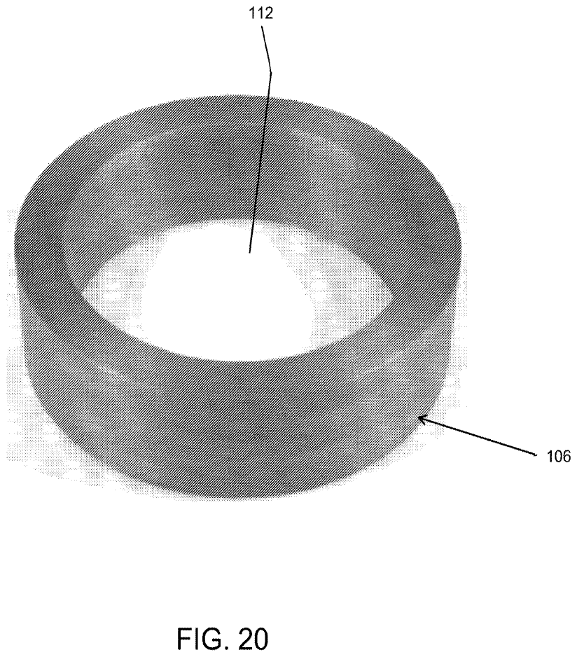

FIG. 20 shows a composite ring with circumferentially aligned carbon fibers formed from polyetheretherketone used as the ring member 106 in the example composite impeller shown.

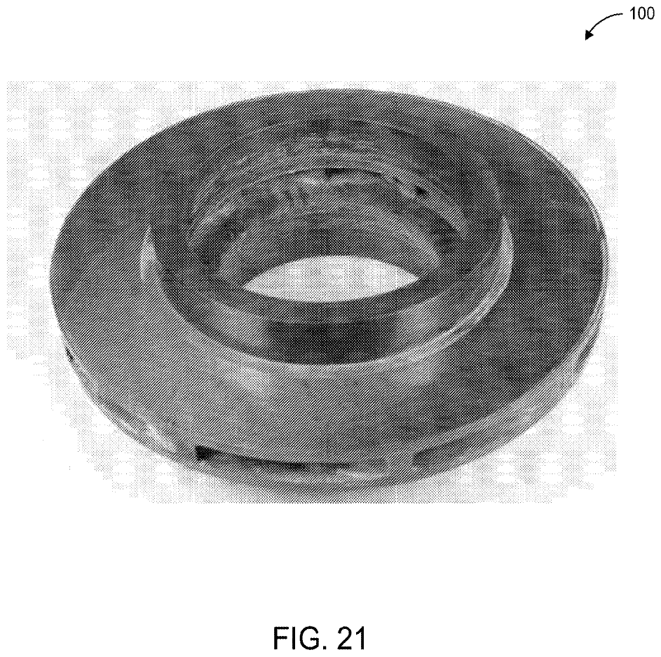

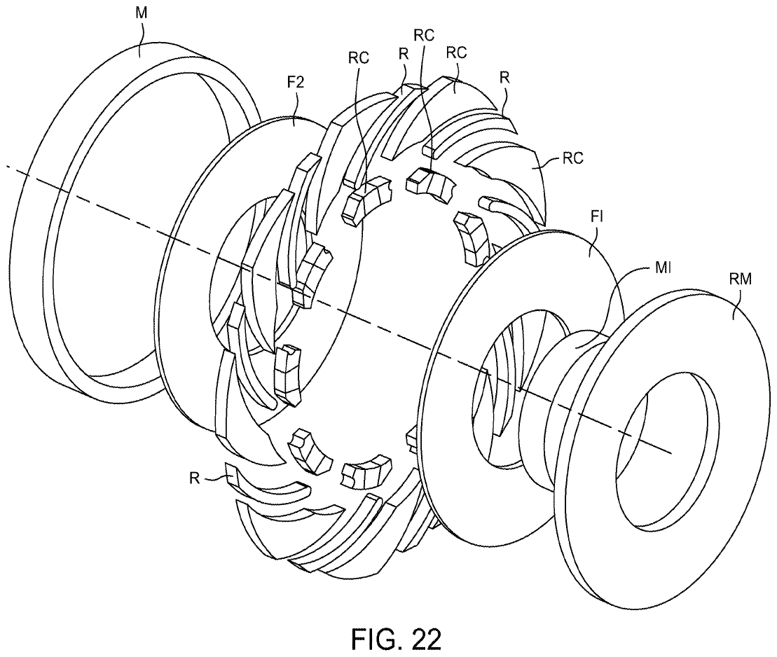

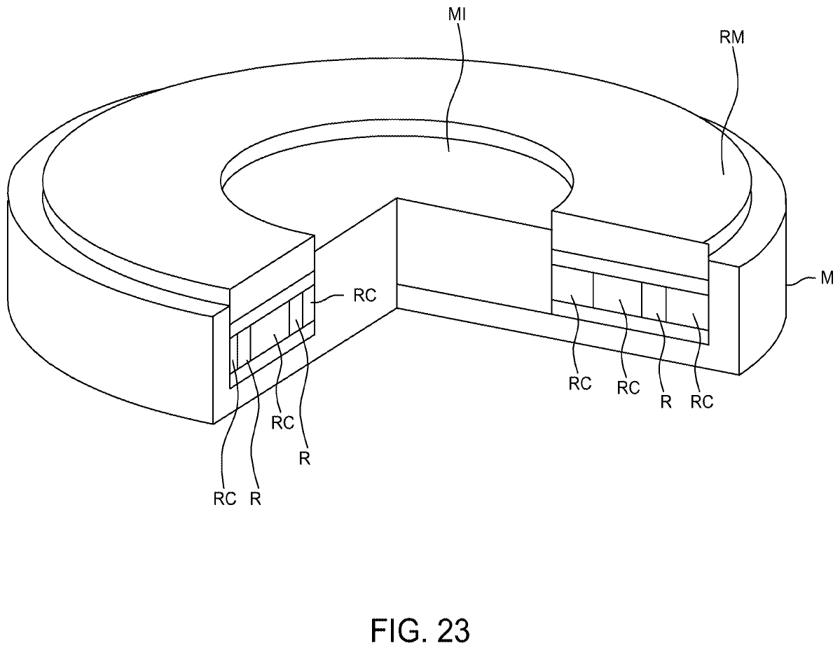

A metal ring was provided and attached to the exterior surface of the machined second composite flange after the impeller was formed. The sample component parts noted above, with the exception of the second ring member (metal ring) were assembled in a mold to form an assembly of the component parts, in this case, an impeller assembly. A removable core was placed in the mold where openings or voids were to remain in the assembled and remolded article. The assembly was placed in a mold, and remolded to form a final composite impeller example according to embodiment 100 as shown in the photo image of FIG. 21. The molding aspects are described with reference to FIGS. 22 and 23. The second ring was then attached to the composite impeller.

In FIG. 22, the component parts are shown in exploded parts in a representative manner. The flange plates shown as items F1 and F2 are molded using a mold as in FIG. 16, and machined to shape (no features are shown in the representative drawing). The ribs are machined from a curved plate formed using the mold shown representatively in FIG. 17. This provides ribs R. The parts are reassembled into a mold base M preferably having a desired shape for the final article and an optional mold insert MI. Cavities within the assembled structure being filled by removable cores RC, shown representatively as here as a collapsible mandrel(s). A ram RM then applies pressure on top of the completed assembly.

The assembled pieces are shown in cross-section in FIG. 23. The finished assembly is remolded in the mold, and the removable core(s) RC are removed.

Various mold designs may be used as are known in the art, and be designed for any of a number of different multi-component articles such as the impellers exemplified herein.

Other component compression parts may be employed or one or more than two flanges may be used in the design as shown. Further the number of ribs may vary in the impellers without departing from the invention.

Whenever there are openings in the final part, removable cores are used in the assembly. As would be known by one skilled in the art, based on this disclosure, and depending on the polymeric matrix material used, the removable core(s) could be extractable cores, collapsible mandrels, machinable cores, soluble cores, meltable cores, inflatable bladders or any other removable core known or to be developed in the relevant art.

The molding conditions including the temperature and pressure will vary depending on the polymeric matrix polymer with varying fillers and reinforcing fiber as would be known in the art. For example, in using a carbon/PEEK composite, in one example impeller, the mold was heated in a hot press to about 400 °C, although processing temperatures between about 360 °C and 430 °C may be used. Typical process pressures of about 10 bar to about 150 bar may also be used on this particular material. This is a high-temperature performance thermoplastic, such that one skilled in the art would know to adjust the temperature and pressure for less or more demanding materials according to their melting and molding profiles.

Once the mold is removed, the mold is cooled. Cooling may be through controlled cooling exchangers, cooling baths, convection or other suitable methods. The molded impeller part is then removed from the mold, and the removable core(s) are then removed or otherwise disposed of, such as by machining, dissolution or other acceptable techniques. At this stage, further machining to final or near final shape may be undertaken if needed.

From sample impellers formed according to the methods herein, the applicant determined that results in use were further improved by modifying the initial impeller design to modify the thickness of the ring members on the respective upper exterior surface and lower exterior surfaces of the flanges and/or by optionally incorporating outer banding rings around the circumferential outer surface of the flanges.

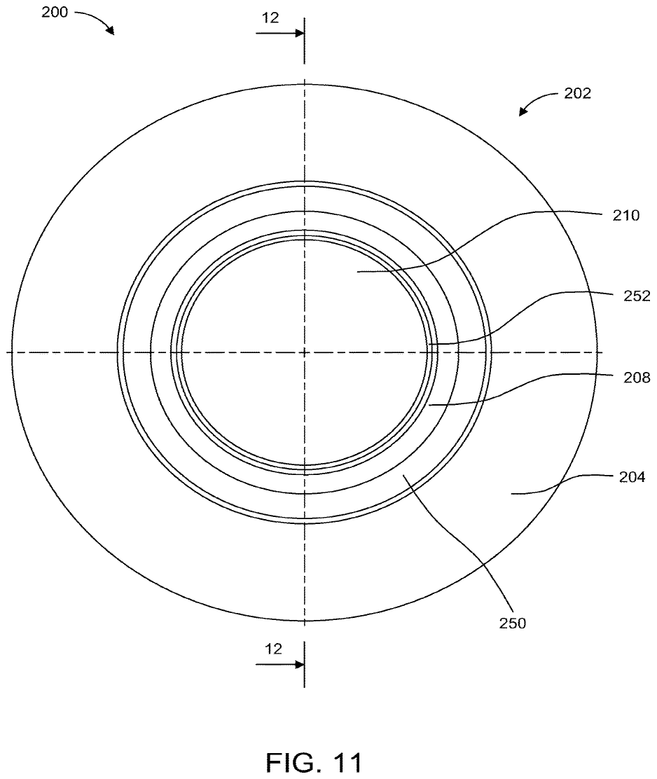

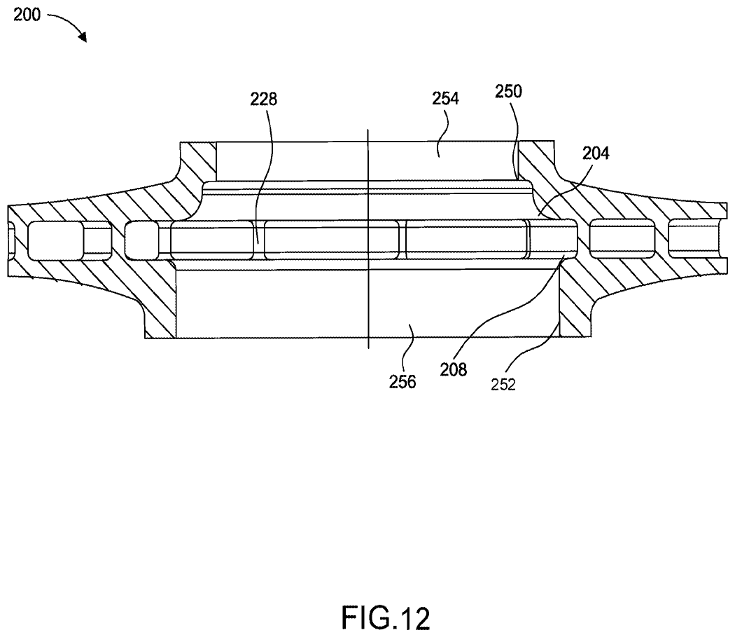

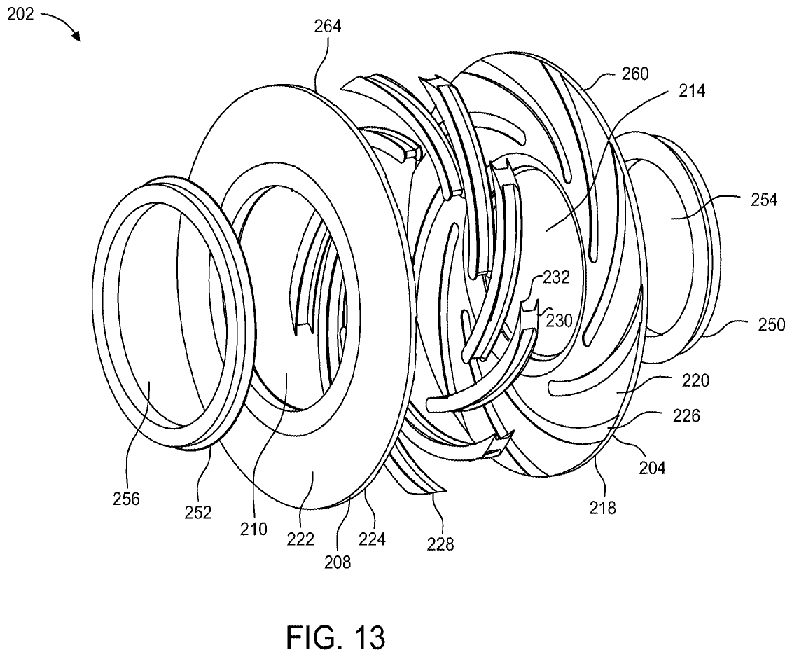

In a further embodiment 200 shown in FIGS. 11-14, a modified impeller design is included. This embodiment differs from the prior embodiment and its variations with respect to the orientation of the flanges, with embodiment 100 using an upper first ring member on top of the quasi-isotropic laminates (that may be joined or molded as one with the flange), and embodiment 200 using a quasi-isotropic laminate throughout the flanges including upper and lower ring members that are unitary within the structure. The embodiments also show variations in the shape of the flanges, providing different machined features to allow attachment of the impeller to the shaft. Both embodiments 100, 200 herein and their modified features are only two possible embodiments of an impeller as claimed and represent only a few examples of multi-component parts that may be made using the methods herein.

In one aspect in which the impeller was modified, upper and lower ring members 250, 252 were incorporated such that a first upper ring member 250 was formed as part of the exterior surface of the modified first composite flange 204. The composite flange was modified to extend upwardly in the interior area defining the opening 214 through the composite flange 204. A second lower ring member 252 was similarly formed as part of the exterior surface of the modified second composite flange 208 so as to engage a modified interior of the flange and define the opening 210 extending therethrough. The upper and lower ring members 250, 252 were each formed of the same composite with the flanges as one component part and include in the ring members long continuous fiber at least a portion of which is substantially aligned to extend in a generally circumferential direction. The ring members 250, 252 designed in this manner have reduced stress concentration in the area around the interior of the flanges in operation.

The thickness, as measured longitudinally along the first and second composite flanges was also formed so as to become thicker on a gradually and generally sloped basis along the radius of the flange without changing any other feature of said flanges compared to prior embodiments shown. For example, the flanges are sloped when moving inwardly in a transverse direction from the outer circumference of the flanges towards the center area of the flanges defining the openings therethrough, making the flanges structurally thicker in the longitudinal direction as they approach the axial center of the assembly, while maintaining the interior surface 220 of the first composite flange 204 and the interior surface 224 of the second composite flange 208 generally planar while still each incorporating surface features 226 to engage impeller ribs 228. The first side 230 of the rib(s) engages the surface features 226 of the interior surface 220 of the first composite flange 204, and the second side 232 of the ribs 228 engages the surface features 226 on the interior surface 224 of the second composite flange 208. The thicker central area of the exterior of the flanges near the axial center of the impeller when formed further acts to reduce stress when the impellers are used in very high speed operations.

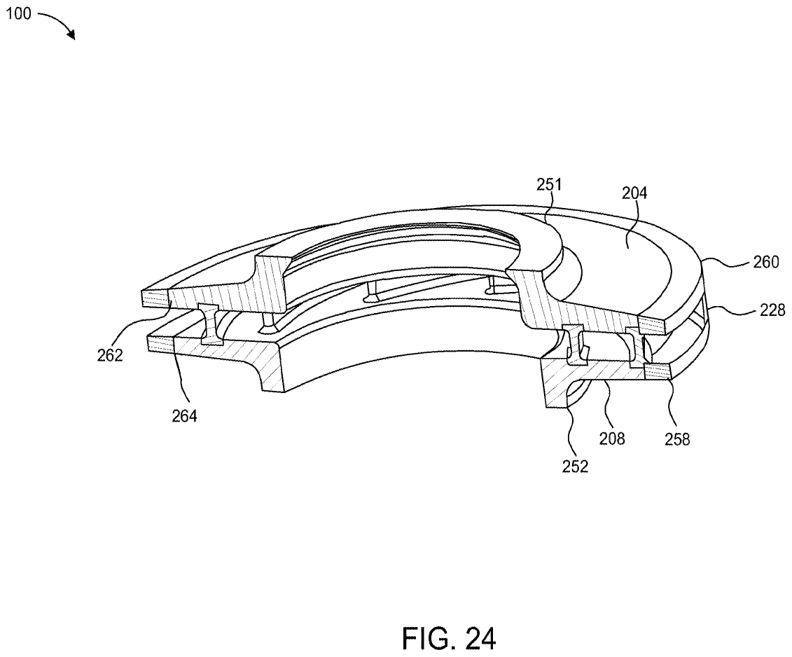

In a further preferred optional modification, as shown in FIG. 24, on the periphery of the first composite flange 204 and the second flange 208 in the assembly of 202, additional features are provided. Each of the composites flanges in assembly 202 has a preferred circumferential outer periphery (as does embodiment 102). The outer periphery of each flange is defined as respective outer surfaces 262, 264. Each outer surface 262, 264 respectively extends longitudinally between the respective interior surfaces 220, 224 and the respective exterior surface 218, 222 of each of the composite flanges 204, 208. The outer surfaces 262, 264 of the first flange and the second flange are engaged also in a preferred embodiment by further larger outer banding rings as shown in the embodiment of FIG. 24. A first outer banding ring 260 is situated around the first composite flange to engage the outer surface 262 thereof. The second outer banding ring 258 is situated around the second composite flange to engage the outer surface 264 thereof. The banding rings 260, 258 may also be made to slope generally upwardly in the direction towards the axial center assembly from the outer periphery if desired. The outer banding ring(s) is/are configured to be positioned circumferentially around and in engagement with the outer surfaces of the first and second flanges. The outer banding rings may also help reduce stress in the internal diameter (ID) axial interior of the composite flanges in the impeller for high speed operation. The banding rings described herein help to lock in the ribs 228 within the features 228 by engaging the mating area where the ribs and flanges are molded together in the assembly.

The outer banding rings may comprise a third composite material, which may be the same as the composite material used to form other components in the assembly and finished structures, and preferably also has at least a portion of unidirectionally oriented fibers generally extending in a circumferential direction. As noted above, one or two such outer banding rings may be employed in the impeller which may further have at least one ring member including the rings noted above, and one or two outer banding rings configured to be positioned circumferentially around and to engage the outer surface of the second flange.

In forming the outer banding rings 260, 258, an automated tape layup, preferably tape winding, may be used to prepare the laminate. However, any suitable laminate to form these features may be used. In preparing the banding rings, one skilled in the art preferably would try to achieve close to unidirectional fiber orientation in the banding rings, through other orientations are possible. Regardless of the technique used to form the banding rings 260, 258, it would be molded and incorporated into the assembly of component parts to be remolded and then the remolded assembly may be machined.

An impeller modeled according to the embodiment of FIG. 24 achieved speeds of above about 600 m/s.

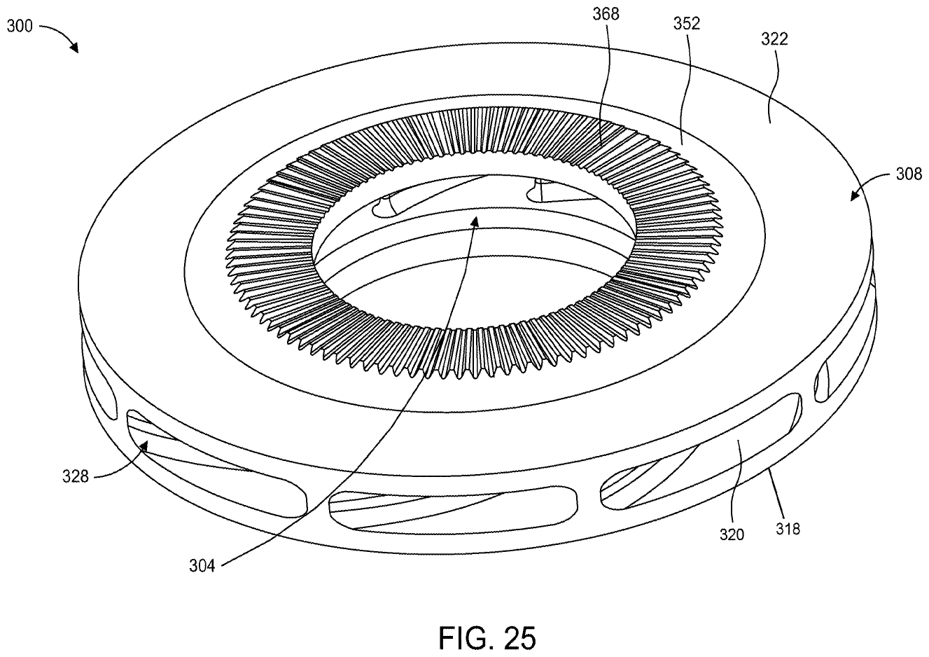

In an additional embodiment 300 shown in FIGS. 25-28, a modified impeller design is included. This embodiment differs from the prior embodiments and their variations with respect to the introduction of Hirth toothing for engaging a drive part, wherein as with prior embodiments, like parts have like reference numbers. The main body of the impeller is otherwise similar to that shown in FIG. 200 with optional banding. Embodiment 300 also uses a quasi-isotropic laminate throughout the flanges 304, 308 including upper and lower ring members 350, 352 that are unitary within the structure and were incorporated such that the first upper ring member 350 was formed as part of the exterior surface of the modified first composite flange 304 in the same manner as embodiment 200. The composite flange 304 defines opening 314 through the composite flange 304. The second lower ring member 352 was similarly formed as part of the exterior surface of the modified second composite flange 308 so as to engage a modified interior of the flange and define the opening 310 extending therethrough. The upper and lower ring members 350, 352 were each formed of the same composite with the flanges as one component part and include in the ring members long continuous fiber at least a portion of which is substantially aligned to extend in a generally circumferential direction as in embodiment 200.

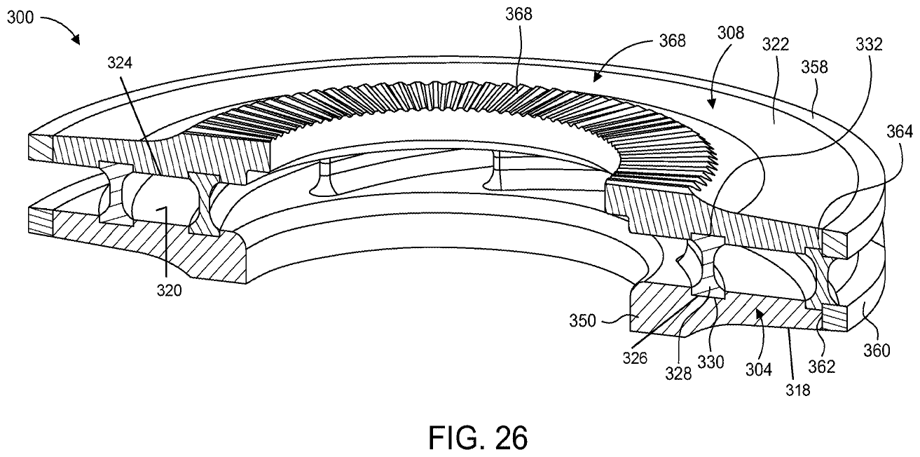

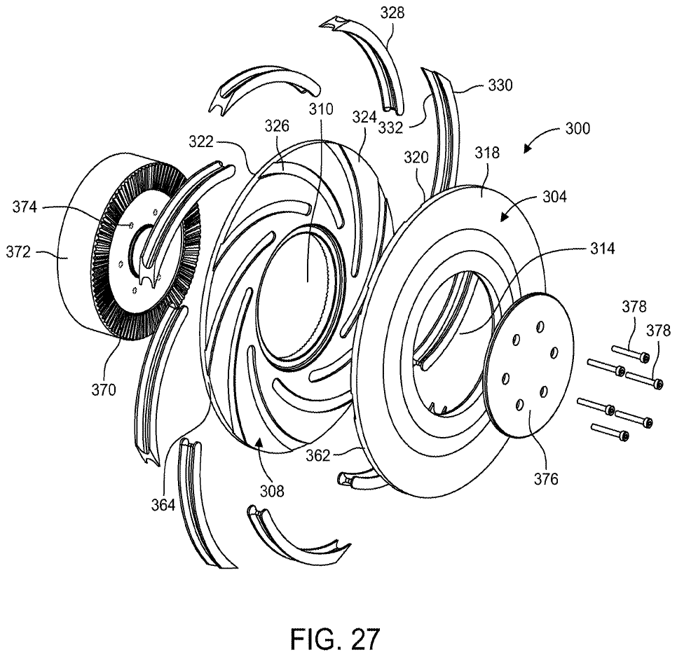

As best shown in FIG. 26, the thickness, as measured longitudinally along the first and second composite flanges was also formed so as to become thicker on a gradually and generally sloped basis along the radius of the flanges without changing any other feature of said flanges compared to prior embodiments shown. However in embodiment 300, the lower sloped portion truncates to be flatter in an inner annular portion 369 thereof to receive the formed Hirth toothing 368 which features may be molded into the exterior surface 322 of the second composite flange 308 in the area where the composite ring 352 was molded into the flange 308. The second composite plate 308 defines opening 310 therethrough. The interior surface 320 of the first composite flange 304 and the interior surface 324 of the second composite flange 308 remain generally planar and incorporate surface features 326 as shown in FIG. 27 to engage impeller ribs 328. The features 326 and the ribs 328 are made in the same manner noted above in prior embodiments 100, 200. As best shown in FIGS. 26 and 27, the first side 330 of the rib(s) engages the surface features 326 of the interior surface 320 of the first composite flange 304, and the second side 332 of the ribs 328 engages the surface features 326 on the interior surface 324 of the second composite flange 308.

In a further preferred optional modification of embodiment 300, as shown in FIG. 26, on the periphery of the first composite flange 304 and the second flange 308 are included on the circumferential outer periphery thereof banding rings. The outer periphery of each flange is defined as respective outer surfaces 362, 364. Each outer surface 362, 364 respectively extends longitudinally between the respective interior surfaces 320, 324 and the respective exterior surface 318, 322 of each of the composite flanges 304, 308. The outer surfaces 362, 364 of the first flange and the second flange are engaged also in a preferred embodiment by further optional larger outer banding rings as shown in the embodiment of FIG. 26. A first outer banding ring 360 is situated around the first composite flange to engage the outer surface 362 thereof. The second outer banding ring 358 is situated around the second composite flange to engage the outer surface 364 thereof. The banding rings 360, 358 may also be made to slope generally upwardly in the direction towards the axial center assembly from the outer periphery if desired. The outer banding ring(s) is/are may be configured to be positioned circumferentially around and in engagement with the outer surfaces of the first and second flanges. The outer banding rings may also help reduce stress in the internal diameter (ID) axial interior of the composite flanges in the impeller for high speed operation. The banding rings can also help to lock-in the ribs 328 within the surface features 326 for further stability as described above with respect to embodiment 200.

The outer banding rings may comprise a third composite material as described above in modified embodiment 200 which includes banding rings, which may be the same as the composite material used to form other components in the assembly and finished structures, and preferably also has at least a portion of unidirectionally oriented fibers generally extending in a circumferential direction. As noted above, one or two such outer banding rings may be employed in the impeller which may further have at least one ring member including the rings noted above, and one or two outer banding rings configured to be positioned circumferentially around and to engage the outer surface of the second flange.

In forming the outer banding rings 360, 358, an automated tape layup, preferably tape winding, may be used to prepare the laminate. However, any suitable laminate to form these features may be used. In preparing the banding rings, one skilled in the art preferably would try to achieve close to unidirectional fiber orientation in the banding rings, through other orientations are possible. Regardless of the technique used to form the banding rings 360, 358, it would be molded and incorporated into the assembly of component parts to be remolded and then the remolded assembly may be machined.

In forming the Hirth toothing, a standard mold surface may be prepared for engaging the second flange 308 plate within the method herein to create the desired toothing design. A preferred design is shown in which the convolutions are evenly spaced around the annular portion 369. Alternatively, the Hirth toothing may be formed as a separately molded plate that may be included in the assembly of component parts to be placed within a molding area of a mold as described herein. Thus, the Hirth toothing may be a separately formed molded plate for later attachment, a separately formed molded plate to incorporate in the assembly to be remolded or formed by a specialty insert surface within the mold body that engages the exterior surface of the second flange plate in the molded component part assembly.

In use, the impeller 300 as shown in FIG. 27 may be fastened to a driving part 372 having a mating Hirth toothing 370 to engage Hirth toothing 368 when installed. Openings 374 may be formed in the drive part 372 to receive connecting fasteners 378. Such fasteners may be snap fit, plug-in mating pieces, threaded or riveted fasteners 378. The drive part 372 serves to center the impeller 300, and fasten it to the driving part for driving the impeller in use. The Hirth toothing 368 on the exterior surface 322 of the second composite flange 308 engages the drive part and may then be fastened to the drive part by way of a counter-piece 376 as shown in FIG. 27 using fasteners 378. As the fasteners and counter-piece tighten, the Hirth toothing mating parts are properly forced together and seated in mating engagement. This is an alternative to having to weld, or otherwise fasten and seat the impellers described herein and provides improved engagement and centering to securely fasten the impeller in use for smooth engagement and rotation, which may provide balance and reduced vibration at higher speeds. Hirth toothing is known in the art for joints or couplings to form a mechanical connection such as between two pieces of a shaft and incorporates tapered “teeth” that engage on each mating portion of the shaft. By providing the teeth in an annular configuration, torque capacity increases with the diameter of the annulus. Incorporation of the Hirth toothing fastener arrangement described herein in composite impeller designs as described herein provides fastening and stability advantages in use and is believed to be novel in the apparatus and methods herein.

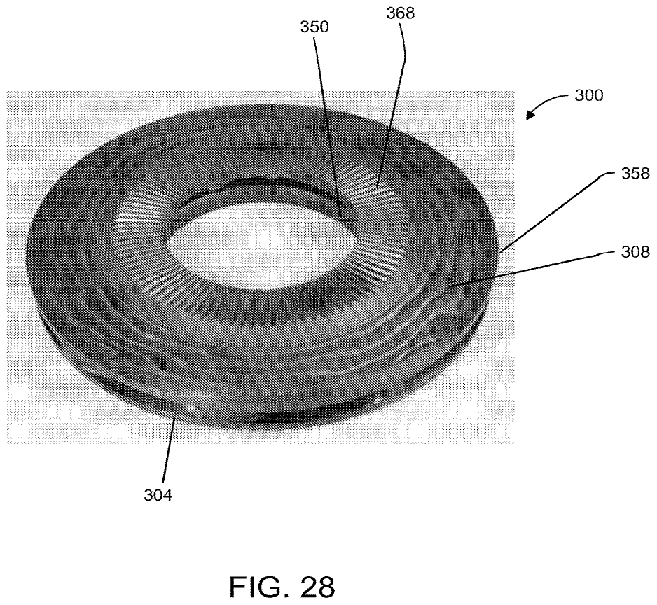

Composite component parts were formed as described in embodiment 200. Removable core material was placed in the mold where openings or voids were to remain in the assembled and remolded article. The assembly was placed in a mold, using a mold plate to form the Hirth toothing, and remolded to form a final composite impeller example according to embodiment 300 as shown in the photo image of FIG. 28.

An impeller modeled according to the embodiments of FIGS. 24 and 25 herein achieved speeds of above about 600 m/s, and are designed to hit higher speeds over 700 m/s or higher.

In each embodiment herein, the impeller is preferably one that is a remolded assembly of at least one first composite flange and at least one rib, and preferably a plurality of ribs and at least one ring member. In preferred embodiments there may be at least two flanges (a first flange and a second flange) or multiple such flanges in series or in different interconnected impeller structures. As noted above, ring members may be used including a composite first ring member as part of the assembly to be molded. An additional optional metal second ring member as in embodiment 100 may be provided to the remolded assembly once formed. The assembly to be remolded may also include flange(s) having upper or lower rings formed as part of the flange composite as in embodiment 200. The assemblies may also include optional outer banding rings on the circumferential outer surfaces of the first and second composite flanges. Such outer banding rings are intended to reduce stress on higher load areas of the formed articles.

The composite(s) used in the various embodiments herein is/are preferably one or more engineering polymers or high-performance thermoplastic polymers or one or more thermosetting polymers as described above.

In preferred embodiments, the openings in the impeller in the final design and in the interior portions of the impeller may be formed using removable core techniques.

The invention also includes a method of forming the multi-component polymeric composite articles, such as the impellers herein in embodiments 100, 200 including preparing at least one first composite flange such as those shown herein or two or more such flanges, each of which may define an opening extending longitudinally therethrough as described above. The first flange(s) include a polymeric composite having the polymeric matrix materials and continuous fibers extending in the longest dimension of the composite part as described herein if making impellers. Similarly, a second composite flange may be prepared defining an opening extending longitudinally therethrough as described above. The second flange may also include a polymeric composite which may be the same or different than that in the first composite flange. For making other multi-component parts, other elements or components may be formed.

In making an impeller, the method may further include preparing at least one rib as described above having a first end and a second end. The first composite flanges(s) and any the second composite flange are then assembled such that the opening in the first composite flange and the opening in the second composite flange are substantially aligned, and preferably fully axially aligned, and the rib(s) is/are situated between the first composite flange and the second composite flange so that the first end of the at least one rib engages the first composite flange, such as by engaging surface features on an interior surface of the first composite flange, and the second end of the rib(s) engage the second composite flange, such as by engaging surface features on an interior surface of the second composite flange, and an impeller assembly is formed.

When making an impeller, these parts are then assembled to form an assembly, in this case an impeller assembly, which is positioned within a mold and a removable core(s) is/are introduced within one or more the openings/voids in the composite assembly so that such openings/voids will remain after remolding. The assembly in the mold is remolded under heat and pressure within the mold. The remolded assembly is cooled and removed from the mold and the removable core(s) are removed to form a composite article such as a composite impeller.

When making an impeller assembly, it may also include at least one ring member. The at least one ring member may include a first ring member having an opening extending longitudinally therethrough, wherein the first ring member is configured for engaging the first composite flange on a side thereof opposite a side of the first composite flange that engages the first end of the at least one rib, wherein the opening in the first flange and the opening in the first ring member are at least substantially aligned.

The at least one ring member may include a second ring member that is a composite ring member if included prior to remolding, or if molded as a single component part of the flange. Such a ring member defines an opening extending longitudinally therethrough for engaging the second composite flange on a side thereof opposite a side of the second composite flange that engages the second end of the at least one rib, wherein the opening in the second flange and the opening in the second ring member are at least substantially aligned, and preferably fully axially aligned.

In the assembly, such one or more ring members (which may be those described in detail above) may be incorporated as noted above on upper and lower portions of the assembly axially aligned on the top and bottom exterior surfaces of the first and second flanges. Further, an outer banding ring(s) may be provided. Such banding ring(s) may be positioned circumferentially around and engage the circumferential outer surface(s) of the first composite flange and/or the second composite flange. Additionally the thickness of the flanges may be increased approaching the central axial area of the flanges to reduce stress.

The at least one ring members may be formed of metal(s), metal alloy(s), or from a polymeric composite, preferably one including a long continuous, generally unidirectional fiber, wherein at least a portion of the fibers therein may in one embodiment be substantially aligned with the component parts within the assembly. Metal rings may be added to the impeller once the component composite parts are remolded and cooled.

Further, the first composite flange, the second composite flange and/or the rib(s) are also preferred to include a polymeric composite having similar long, continuous fiber. The polymeric composites in the invention hereof in various embodiments may include a thermoplastic or thermosetting matrix polymer and at least one continuous long fiber.

The matrix polymer(s) may be those identified hereinabove with preferred matrix materials being high-performance thermoplastic polymers described hereinabove.

In another embodiment, the applicant's apply their method to form a composite article from individual composite component parts, which composite article may be one having at least one opening or void. In the method, a polymeric composite assembly is prepared using one or more polymeric composite component(s) using the matrix materials and fibers described above. The composite assembly is positioned within a mold with a removable core(s) incorporated within void(s) and opening(s) in the composite assembly that are intended to remain as openings or void(s) in the finished article. The polymeric composite assembly is positioned in the mold with heat and pressure applied to remold the assembly into an article. When the article is formed and cooled, it is also removed from the mold, and the removable core(s) is/are then removed to form the polymeric composite article.

In preferred embodiments herein, the article is impeller which may be open or closed, however, other articles may be made using similar materials, method steps and techniques. The composite component(s) used are preferred to include polymeric composite materials as noted above having at least one continuous fiber therein. Such continuous fiber may be long continuous fiber and at least a portion of the fibers in the at least one continuous fiber may be at least substantially aligned. However, other reinforcing fibers and fillers as mentioned above may also be used.

The polymeric composites in the method herein may include thermoplastic or thermosetting matrix polymers as noted above. The removable core(s) in the method may also be removed by various techniques described above.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of forming an impeller comprising:
preparing an impeller assembly of at least two composite pre-preg components, wherein each of the at least two composite pre-preg components are formed from:
a first composite comprising:
a first matrix material comprising a high-performance polymer selected from polycarbonates, linear aromatic polyesters, linear aromatic polyimides, polyurethanes, polyphenylene oxides, polyphenylene ethers, polyphenylene esters, polyphenylene ether esters, polyphenylene sulfides, polysulfones, polyether sulfones, polyphenylsulfones, polymethylpentenes, polyketones, aramids, polyaryl ethers, polyaryl ether ketones, and combinations and co-polymers thereof; and
at least one continuous reinforcing fiber, wherein at least a portion of the fibers of the at least one continuous reinforcing fiber are unidirectionally aligned within the first matrix material, or
a second composite comprising:
a second matrix material selected from at least one thermoplastic polymer or at least one thermosetting polymer;
the least one continuous reinforcing fiber, wherein at least a portion of the fibers of the at least one continuous reinforcing fiber are unidirectionally aligned within the second matrix material,
wherein the at least two composite pre-preg components comprise a first flange and a rib having a first end and a second end, and wherein first flange and the rib are assembled such that the first end of the rib engages the first flange;
positioning the at least two composite pre-preg components of the impeller assembly within a mold; and
remolding the impeller assembly within the mold to form the impeller.

2. The method according to claim 1, wherein preparing the impeller assembly comprises:
forming the first flange by machining a flat composite flange that comprises the first composite or the second composite;
forming the rib by cutting a curved molded plate that comprises the first composite of the second composite; and
assembling the first flange and the rib.

3. The method according to claim 1, further comprising:
placing a removable core within one or more openings or voids in the impeller assembly within the mold; and
removing the removable core after remolding the impeller assembly.

4. The method according to claim 1, wherein the at least one continuous reinforcing fiber in the rib define a 0° fiber orientation along a chord line of the rib.

5. The method according to claim 1, wherein the reinforcing fibers comprise carbon, glass, aramid, metal, metal alloy, or natural fiber.

6. The method according to claim 1, wherein the at least two composite pre-preg components further comprise a second flange that is substantially aligned with the first flange with the rib situated between the first flange and the second flange such that the second end of the rib engages the second flange.

7. The method according to claim 6, wherein an exterior surface of the second flange is formed to comprise Hirth toothing in an inner annular portion of the second flange.

8. The method according to claim 6, wherein the impeller assembly further comprises a first ring member having an opening extending longitudinally therethrough, wherein the first ring member is configured for engaging the first flange on a side thereof opposite a side of the first flange that engages the first end of the rib, and wherein the first ring member comprises a polymeric composite comprising long continuous unidirectionally aligned reinforcing fibers.

9. The method according claim 8, wherein the impeller assembly further comprises a second ring member, wherein the second ring member engages the second flange on a side thereof opposite a side of the second flange that engages the second end of the rib, and wherein the second ring member comprises a metal or a metal alloy.

10. The method according to claim 6, wherein the impeller assembly further comprises at least one outer banding ring positioned circumferentially around and engaging a circumferential outer surface of one or more of the first flange or the second flange.

11. The method according to claim 10, wherein the at least one outer banding ring defines an opening extending longitudinally therethrough configured to engage one or more of the first flange or the second flange on an exterior surface thereof, wherein the at least one outer banding ring is substantially axially aligned with the first flange and the second flange.

12. The method according to claim 1, wherein the impeller in operation is capable of achieving a tip speed of at least about 700 m/s.

13. The method according to claim 1, wherein the second matrix material comprises the at least one thermoplastic polymer and the at least one thermosetting polymer.

14. The method according to claim 1, wherein the first matrix material comprises at least one polyaryl ether ketone selected from polyetherketone, polyetherketoneketone, polyetheretherketone, polyetheretherketoneketone, polyetherketoneetherketoneketone, and combinations and copolymers thereof.

15. The method according to claim 1, wherein the first matrix material comprises an engineering thermoplastic polymer selected from the group consisting of polybutadiene, polyacrylonitrile, poly(butadiene-styrene), poly(styrene-acrylonitrile), melt-processible fluoropolymers, liquid crystalline polymer, polyacetals, polyacrylates, polyamides, polyolefins, polyalkylene terephthalates, polyphthalimides, polyolefins, polyimides, polyetheramides, and combinations and copolymers thereof.

16. The method according to claim 1, wherein the first matrix material comprises ethylene propylene diene rubber, ethylenepropylene rubber, thermosetting polyurethane elastomers, epoxy resins, thermosetting biscitraconicimides, bismaleimides, bismaleimide/triazine/epoxy resins, cyanate esters, cyanate resins, furanic resins, phenolic resins, urea-formaldehyde resins, melamine-formaldehyde resins, phthalocyanine resins, polybenzoxazole resins, acetylene-terminated polyimide resins, silicones, polytriazines, thermosetting polyvinyl esters, thermosetting polyurethanes, polytetrafluoroethylene, melamines, polyalkyds, xylene resins, and combinations and copolymers thereof.

17. A method of forming a polymeric composite impeller having at least one opening comprising:
preparing a polymeric composite assembly of at least two composite pre-preg components, wherein each of the at least two composite pre-preg components comprise:
at least one continuous reinforcing fiber; and
a first matrix material comprising a high-performance polymer selected from polycarbonates, linear aromatic polyesters, linear aromatic polyimides, polyurethanes, polyphenylene oxides, polyphenylene ethers, polyphenylene esters, polyphenylene ether esters, polyphenylene sulfides, polysulfones, polyether sulfones, polyphenylsulfones, polymethylpentenes, polyketones, aramids, polyaryl ethers, polyaryl ether ketones, and combinations and co-polymers thereof; or
a second matrix material selected from at least one thermoplastic polymer or at least one thermosetting polymer, the polymeric composite assembly having at least one opening therein;
positioning the at least two composite pre-preg components of the polymeric composite assembly within a mold and incorporating a removable core within the at least one opening in the polymeric composite assembly; and
remolding the polymeric composite assembly within the mold and removing the removable core to form the polymeric composite impeller.

18. The method according to claim 17, wherein the at least two composite pre-preg components comprise the same matrix material.

19. The method according to claim 17, wherein the at least one continuous reinforcing fiber comprises carbon, glass, aramid, metal, metal alloy, or natural fiber.

20. A method of forming an impeller for use with centrifugal compressors or pumps via thermoplastic remolding comprising:
forming a first composite component comprising a flange, wherein the first composite component comprises:
a first matrix material, wherein the first matrix material is a high-performance thermoplastic polymer selected from the group consisting of polycarbonates, linear aromatic polyesters, linear aromatic polyimides, polyurethanes, polyphenylene oxides, polyphenylene ethers, polyphenylene esters, polyphenylene ether esters, polyphenylene sulfides, poly sulfones, poly ether sulfones, polyphenyl sulfones, polymethylpentenes, polyketones, aramids, polyaryl ethers, polyaryl ether ketones, and combinations and co-polymers thereof, and
at least one continuous reinforcing fiber comprising carbon, glass, aramid, metal, metal alloy, or natural fiber;
forming a second composite component comprising at least one rib, wherein the second composite component comprises:
a second matrix material selected from at least one thermoplastic polymer or at least one thermosetting polymer, and
the at least one continuous reinforcing fiber is arranged in a 0° fiber orientation along a chord line of the at least one rib;
assembling the first composite component and the second composite component such that the at least one rib engages the flange to form an impeller assembly;
positioning the impeller assembly within a mold; and
thermoplastic remolding the impeller assembly to consolidate the first composite component and the second composite component into a unitary impeller structure.
